(19) United States
(12) Patent Application Publication
(10) Pub. No.: US 2003/0006879 A1
(43) Pub. Date: Jan. 9, 2003

(54) Security access system with wireless identification

(76) Inventors: Joong-Gil Kang, Dongrae-gu (KR); Hyun-Gug Cho, Suyoung-gu (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/178,897

(22) Filed: Jun. 20, 2002

Related U.S. Application Data
(63) Continuation-in-part of application No. PCT/KR01/01777, filed on Oct. 20, 2001.

(30) Foreign Application Priority Data
Oct. 20, 2000 (KR) 2000/62028
Feb. 7, 2001 (KR) 2001/5900
Apr. 27, 2001 (KR) 2001/23102
Mar. 13, 2001 PCT/KR01/00390

(51) Int. Cl. H04Q 1/00; G05B 19/00

(52) U.S. Cl. 340/5.61

(57) ABSTRACT

The present invention relates to a door control system using radio communication. According to the invention, a main device controls the opening and closing of a door by using a portable wireless card. The main device comprises a long wave emitting portion, a very high frequency wave receiving portion, a very high frequency wave emitting portion, memory, processor and recording media in which a program that is executable by the processor is recorded. The portable card comprises a long wave receiving portion, a card processor and recording media in which a program that is executable by the card processor is recorded.

### RELATED APPLICATIONS

This application is a continuation-in-part under 35 U.S.C. §365 (c) claiming the benefit of the filing date of PCT Application No. PCT/KR01/01777 filed Oct. 20, 2002, designating the United States and claiming for the benefit of the earlier filing dates under 35 U.S.C. §365 (b) of Korean Patent Application Nos. 2000/62028 filed Oct. 20, 2000; 2001/5900 file Feb. 7, 2001; and 2001/23102 filed Apr. 27, 2001; and International Application No. PCT/KR01/00390. International Application Nos. PCT/KR01/01777 was published in English as WO 02/38895 A1 on May 16, 2002, and is hereby incorporated herein by reference.

### BACKGROUND OF THE INVENTION

1. Field of the Invention

The present invention relates to a door controlling system using radio communication and, particularly, is directed to a controlling system for controlling and watching a building door and vehicle door.

2. Description of the Related Art

Conventionally, a mechanical means based on lock and key is used as a device for opening and shutting a building door. Recently, locking device such as a card key and a sensor device that uses characteristic such as fingerprint and iris, by which a human can be identified, have been developed recently.

However, the devices are difficult to use since, in order to open or shut the door, the key should be mechanically operated to release the lock, the card key should be contacted with the sensor, or fingerprint or iris should approach near the sensor.

Further, security can be threatened by intentional destructive action since most of the conventional devices are exposed to the outside.

There has been trial of constituting home automation system using the opening and closing devices for a conventional building door. In most cases, main controller and sensor are connected by wire to each other and control operation is performed based on the sensing result. However, since the system is operated with wire, if the system is additionally applied to an constructed building, wires of the system should be disposed in the outside of the building. Thus, the home automation system based on the conventional wired control has limitation to space and does not have fine outer view. Further, it takes long time to install the system including wire positioning and thus, it is reality that it is difficult to use the system in a practical use.

The conventional home automation system using radio communication, is expensive since the system requires main control device that is exclusively used for home automation and controlling unit and alarm device that is to be mounted in a door and electronic appliances.

A vehicle door controlling system that opens/closes a vehicle door wirelessly and switches on the ignition in order to provide convenience to a driver of the vehicle and in order to prevent car theft, was developed and has been widely used. Korean Patent Publication No. 1990-6095 discloses such a controlling system. The device comprises a main controlling unit that is provided inside a vehicle and only a driver having remote-control where the same password as the password recorded in the main controlling unit is stored can open/close the vehicle door and can switch on/off the ignition. When a person who does not carry the remote-control approaches the vehicle, the device detects it and alarms or repels the person.

However, a user should perform cumbersome operations to buttons of the remote-control one by one when opening/closing the vehicle door in the event that the user uses the device. Further, mis-operation frequently occurs due to interference of electromagnetic wave that is generated from electronic devices

Korean Patent Publication No. 1991-7176 discloses a device for resolving the problems of the conventional art. According to the device, a door locking unit is unlocked when a driver carrying a remote-control approaches the vehicle without carrying vehicle key and the door locking unit is locked when the driver carrying the remote-control the vehicle. After the door is locked, the device acts as role of a burglar alarm.

However, according to the technique, long wave transceiver for transmitting and receiving long wave (LF) in band of 100 kHz and very high frequency transceiver for transmitting and receiving very high frequency (VHF) use the same frequency band designated in the frequency for vehicle defined in Electronic Wave Managing Act. The device is adapted not to modulate the long wave signal and to transmit the signal to automatic-transmission wireless remote-control.

Therefore, a mercury cell of the card is rapidly used up since the circuit is continuously operated if automatic-transmission wireless remote-control approaches TV, monitor for computer, electronic copier, three wave fluorescent lamp and the like which generate feeble electronic wave in the band of 100 kHz and near wave length thereof, and electric and electronic equipments generating strong electronic wave.

Further, if many automatic-transmission wireless remote-control approach one vehicle, all of the automatic-transmission wireless remote-controls that are within detecting distance for long wave are operated simultaneously and thereby, the very high frequency transceiver of the remote-controls transmits characteristic data simultaneously. Further, the very high frequency receiving unit of the vehicle cannot read the predetermined characteristic data because of the same frequency.

In the field other than the present invention, there is a technique wherein bilateral communication without power is possible. According to this technique, the detecting distance is up to 30 cm and thus, the object described in the above cannot be accomplished. If bilateral communication using general flashlight battery is used, the card receiving format is very high frequency receiving format, not ultra-power-saving long wave receiving format. Thus, the consumption of current cannot be minimized in standby state because of standard bias current of a circuit. Even if the very high frequency transmitting unit of the card is intermittently operated not being operated continuously in order to reduce to-be-consumed current, the consumed current at the time of operation is several mA. Thus, very small mercury cell whose capacity is below 200 mA only can be used for 10 days and thereby, the commercialization is impossible.

### SUMMARY OF THE INVENTION

An aspect of the present invention provides a wireless identification device for use with an identification checking system. The device comprises: means for receiving a first wireless signal from a source; means for wireless-transmitting a first responsive signal incorporating a random security code; means for receiving a second wireless signal from the source; means for checking whether the second wireless signal incorporates a derivative code of the random security code; and means for wirelessly transmitting a second responsive signal confirming the incorporation of the derivative code into the second wireless signal. The first responsive signal further incorporates an identification code of the device. The first and second wireless signals have a carrier frequency in the range of low frequency (LF). The first and second responsive signals have a carrier frequency in the range of very high frequency (VHF).

Another aspect of the present invention provides a wireless security access system. The system comprises: a portable unit; a control unit; wherein the portable unit comprises: means for receiving a first wireless signal, means for wireless-transmitting a first responsive signal incorporating a random security code, means for receiving a second wireless signal, means for checking whether the second wireless signal incorporates a derivative code of the random security code, and means for wirelessly transmitting a second responsive signal confirming the incorporation of the derivative code into the second wireless signal; and wherein the control unit comprises: means for transmitting the first and second wireless signals, means for receiving the first and second responsive signals transmitted from the device, means for processing the first responsive signals and for generating the second wireless signal incorporating the derivative code, and means for controlling operation of an access device upon the receipt of the second responsive signal. The access device is a door installed in a building. The access device is a vehicle.

Another aspect of the present invention provides a wireless security access system. The system comprises: a control unit configured to transmit an initiating wireless signal; a portable unit configured to recognize the initiating wireless signal and programmed to initiate two-way wireless communications with the control unit upon the recognition of the initiating wireless signal, wherein the two-way wireless communication between the control and portable units are designed to identify each other, and wherein the control unit is programmed to issue a command upon the mutual identification by the control and portable units; and a locking device is configured to operate in accordance with the command from the control unit. The two-way wireless communications comprises: a random code signal from the portable unit to the control unit, the random code signal representing a random code; and a derivative signal from the control unit to the portable unit, the derivative signal representing a derivative of the random code. The two-way wireless communications further comprise an identification signal from the portable unit to the control unit, and wherein the identification signal represents an identification code of the portable unit. The portable unit is programmed to transmit the identification signal along with the random code signal. The two-way wireless communications further comprise a confirmation signal being communicated from the portable unit to the control unit, confirming completion of the mutual identification. The random code comprises a random period code. The locking device is configured to lock a door of a building or a vehicle. The locking device is for a vehicle door, and wherein the control unit is configured to further issue a signal for ignition of an engine of the vehicle. The locking device comprises a locking member for locking the door, a solenoid configured to rotate the locking member and an engagement member configured to prevent the locking member from rotating. The control unit is further configured to issue another command for an electrical device. The control unit is further configured to communicate through a telephone line, and wherein the command for the electrical device is based on communication through the telephone line.

Still another aspect of the present invention provides a method of identifying a counterpart of wireless communication. The method comprises: detecting by a portable unit a first wireless signal with an intensity level equal to or higher than a predetermined level; upon the detection of the first wireless signal with the intensity level, wirelessly transmitting from the portable unit a signal representing an identification code of the portable unit and a random security code; receiving by the portable unit a second wireless signal incorporating a derivative code of the security code; and wirelessly transmitting from the portable unit a confirmation signal confirming the incorporation of the derivative code into the second wireless signal. The portable unit is in a low power consumption mode before detecting the first wireless signal with an intensity equal to or higher than the predetermined level. The method further comprises the portable unit's changing the power consumption to a mode of increased power consumption upon the detection of the first wireless signal with an intensity equal to or higher than the predetermined level. The method further comprises the portable unit's changing the power consumption to the increased power consumption mode only while the portable unit is in motion.

Still another aspect of the present invention provides a process of operating a security access system. The process comprises: transmitting a first wireless signal from a control unit; receiving the first wireless signal by a portable unit; generating and transmitting by the portable unit a second wireless signal in response to the first wireless signal, the second wireless signal comprising a signal identifying the portable unit; receiving the second wireless signal and identifying the portable unit based on the identifying signal by the control unit; and transmitting from the control unit a command signal for an operation of a locking device. The second wireless signal further comprises a signal indicative of a random security code. The process further comprises the control unit's generating and transmitting a third wireless signal comprising a security signal. The second wireless signal further comprises a random security code, and wherein the security signal of the third wireless signal is derivative of the random security code. The second wireless signal further comprises a signal indicative of a random security code, and wherein generating the security signal of the third wireless signal comprises frequency-converting the signal indicative of the random security code. The process further comprises the portable unit's receiving the third wireless signal and identifying the security signal from the control unit. The second wireless signal further comprises a random security code, and wherein the identification of the security signal comprises confirming that the security signal represents a derivative code of the random security code. The process further comprises the portable unit's generating and transmitting a fourth wireless signal in response to the identification of the security signal. The process further comprises the control unit's receiving the fourth wireless signal, and wherein the control unit transmits the command upon the receipt of the fourth wireless signal. The process further comprises changing or maintaining power consumption in the portable unit to a mode of minimum power consumption when the intensity of the received first wireless signal is lower than a predetermined level. The process further comprises changing the power consumption in the portable unit to a mode of increased power consumption when the intensity of the received first wireless signal is equal to or higher than the predetermined level. The portable unit is activated upon the receipt of a predetermined intensity of the first wireless signal. The transmission of the command signal for the locking device is either wireless-transmission or wire-transmission. The locking device is configured to lock or unlock a door. The door comprises a door of a vehicle or a building. The control unit is installed in the vehicle or the building.

A further aspect of the present invention provides an apparatus for identifying a counterpart of wireless communication. The apparatus comprises: a receiver for receiving incoming signals; a processor for processing the received signals; a transmitter for transmitting signals; and wherein the processor is programmed to isolate an encrypted code from the incoming signals and to generate a derivative code of the encrypted code, and wherein the transmitter is configured to transmit a reply signal incorporating the derivative code. The encrypted code is a random period code.

The present invention further provides a controlling system for controlling opening/closing a door in particular, door of a vehicle or a building using radio communication. The present invention further provides a controlling system using the radio communication, which prevents a batter from being used up rapidly due to repetition of locking and unlocking in the event that a wireless card continuously exists within a wave detecting distance and which can be unlocked in the emergency situation such as in the situation that the battery is used up completely. The present invention further provides home automation system which can control the indoor electronic appliances outside the house, with lower cost.

According to the present invention, a system wherein a main unit controls door opening/closing using a portable wireless card carried by a person. The main unit comprises a long wave transmitting unit for generating and transmitting long wave, a very high frequency receiving unit for receiving very high frequency, a very high frequency transmitting unit for generating and transmitting very high frequency, a memory, a processor, and a recording medium having a program recorded therein. The program that is executed by the processor of the main unit performs a step (s1) of periodically transmitting a first long wave including synchronous signal through the long wave transmitting unit and an unlocking commanding step (s2) of, if the very high frequency receiving unit receives very high frequency including ID code, determining whether ID code that is identical with the received ID code is recorded in the memory, and then if it is determined that the ID code is recorded in the memory, transmitting the very high frequency including unlocking command through the very high frequency transmitting unit. The portable wireless card comprises a card long wave receiving unit for receiving long wave, card very high frequency transmitting unit for transmitting very high frequency, a card processor and a recording medium having a program recorded therein. The program that is executed by the card processor performs a step (c1) of transmitting very high frequency including ID code through the very high frequency transmitting unit if the card long wave receiving unit receives the first long wave; and the object device locking controlling unit performs a step of unlocking the object device if the very high frequency including unlocking command is received.

According to another aspect of the present invention, the door controlling system further comprises a telephone controlling unit and device controlling unit to control indoor home electronic appliances. The telephone controlling unit comprises conversion switch for, if telephone signal inputted from outside telephone line is not DTMF signal, switching to outside telephone, DTMF converting unit for converting DTMF signal inputted form the outside telephone line and signal that can be processed by processor, reciprocally, a processor, and a recording medium having a program recorded therein. The program that is executed by the processor performs a step of detecting signal inputted through the DTMF converting unit, and if the detected signal includes a selected control signal, sending the detected control signal to the processor of the main unit.

The device controlling unit is for controlling the controlled device corresponding to the device characteristic code according to the device control command, if fifth very high frequency including device characteristic code corresponding to the controlled device and device control command is received. The program that is executed by the main unit processor further performs a step of separating the device characteristic code and device control command from the control signal sent from the telephone controlling unit and transmitting the fifth very high frequency including the code and command through the very high frequency transmitting unit.

According to the further aspect of the present invention, a door controlling method is provided which uses a main unit, a portable wireless card, a door locking controlling unit. The main unit performs a step of periodically transmitting first long wave including synchronous signal; a step of, if first very high frequency including ID code and period code is received, determining whether ID code that is identical with the received ID code is recorded, and then if it is determined that the same ID code is recorded, converting the period code into long wave ID and transmitting second long wave including the ID; a step of, if second very high frequency including ID code is received, determining whether the same ID code as the received ID code is recorded, and then, if the same ID code is recorded, transmitting third very high frequency including unlocking command; and a step of, if fourth very high frequency including unlocking confirming signal is received, informing unlocking of the object device. The portable wireless card performs a step of, if the first long wave is received, transmitting first very high frequency including ID code and period code; and a step of, if the second long wave is received, comparing the long wave ID with the period code; and then, if it is determined that the ID is identical with the period code, transmitting second very high frequency including the ID code and unlocking requesting signal. The door locking controlling unit performs a step of unlocking the object device and transmitting fourth very high frequency including unlocking confirming signal, if the third very high frequency is received.

According to the preferred embodiment of the present invention, the object device locking controlling unit is mounted on a frame where the object device is installed, such as a doorframe. According to the present invention, the object device locking controlling unit comprises driving means that is operated according to unlocking signal or locking signal received from the main unit, engagement member that is fixed in the driving means and that can be rotated according to the operation of the driving means, and driving member that can be rotated and where fixing member of the door is engaged with. In the locking state, the engagement member is engaged with the driving member, thereby preventing rotation of the driving member. In unlocking state, the engagement member is rotated by the operation of the driving means, thereby releasing the engagement with the driving member and rotating the driving member.

According to the still further aspect of the present invention, a vehicle door/ignition controlling system is provided. The controlling system comprises a main unit, a portable wireless card and remote-control transmitting unit. The main unit comprises long wave transmitting unit for generating and transmitting long wave, very high frequency receiving unit for receiving very high frequency, memory, processor and recording medium having a program recorded therein. The program that is executable by the processor performs a step (a) of periodically transmitting first long wave including synchronous signal through the long wave transmitting unit, a step (b) of, if the very high frequency receiving unit receives first very high frequency including characteristic data, detecting the characteristic data from the received first very high frequency, determining whether the data is identical with characteristic data recorded in the memory and then if it is determined that the data is identical, transmitting second long wave, a step (c) of, if second very high frequency including characteristic data and door unlocking signal is received, detecting characteristic data from the received second very high frequency, determining whether the data is identical with characteristic data recorded in the memory, and then if it is determined that the data is identical, unlocking the door. The portable wireless card comprises card long wave receiving unit for receiving long wave, card very high frequency transmitting unit for transmitting very high frequency, card processor, and recording medium having a program recorded therein. The program that is executable by the card processor performs a step (a) of, if the card long wave receiving unit receives the first long wave, transmitting first very high frequency including characteristic data, a step (b) of, receiving the second long wave, detecting characteristic data included in the received second long wave, and then, if it is determined that the characteristic data is identical with the data recorded in the memory, transmitting second very high frequency including characteristic data and door unlocking command. The remote-control transmitting unit is mounted inside the vehicle and transmits a plurality of operation signals to the main unit.

According to the other embodiment of the present invention, the object device controlling system is characterized in that the portable wireless card further comprises sensor for detecting movement of the portable wireless card and the portable wireless card is adapted to be operated only when the sensor detects that the portable wireless card moves. According to this constitution, the battery consumption can be minimized.

Further, the operation signal between the remote-control transmitting unit and the main unit can be performed by wire or wirelessly by very high frequency.

### BRIEF DESCRIPTION OF THE DRAWINGS

FIG. 1 shows a block diagram showing the entire constitution of building door controlling system using radio communication according to an embodiment of the present invention.

FIG. 2 shows a block diagram explaining operation of controlling indoor electronic appliances of the building outside, using building door controlling system using radio communication according to an embodiment of the present invention.

FIG. 3 shows a block diagram showing main unit (1100) in the building door controlling system using radio communication according to an embodiment of the present invention.

FIG. 4 shows a block diagram showing wireless card (1200) in the building door controlling system using radio communication according to the present invention.

FIG. 5 shows a block diagram showing door locking unit (1300) in the controlling system using radio communication according to the present invention.

FIG. 6 shows a flowchart for explaining the operation of the building door controlling system according to the present invention.

FIG. 7 shows a flowchart for explaining process of controlling indoor electronic appliances using building watching and controlling system which is constituted from main unit for building (1100), telephone controlling unit (1150), controlling unit of electronic appliances (1410, 1420, 1430) and wireless intrusion detecting unit (1110).

FIG. 8 shows time flow chart showing wave and signal that are transmitted during the operation of building watching and controlling system according to the present invention.

FIG. 9 shows a table showing the demodulated signals and the category of waves and signals that are transmitted during the operation of the building watching and controlling system according to the present invention.

FIGS. 10 and 11 show conceptual drawings showing installation of door locking unit according to an embodiment of the present invention.

FIG. 12 shows a block diagram of vehicle door/ignition controlling unit using a portable wireless card according to the present invention.

FIG. 13 shows a detailed block diagram of a main unit in the vehicle door/ignition controlling unit using the portable wireless card according to the present invention.

FIG. 14 shows a detailed block diagram of the portable wireless card in the vehicle door/ignition controlling unit using the portable wireless card according to the present invention.

FIG. 15 shows a detailed block diagram of remote-control transmitting unit in the vehicle door/ignition controlling unit using the portable wireless card according to the present invention.

FIG. 16 shows a system timing chart of the vehicle door/ignition controlling unit using the portable wireless card according to the present invention.

FIG. 17 shows a detailed circuit diagram of the main unit and vehicle controlling unit according to the present invention.

FIG. 18a shows a detailed circuit diagram of long wave transmitting unit of the main unit according to the present invention.

FIG. 18b shows a detailed circuit diagram of very high frequency receiving unit of the main unit according to the present invention.

FIG. 19 shows a detailed circuit diagram of the portable wireless card according to the present invention.

FIG. 20 shows a detailed circuit diagram of the remote-control transmitter according to the present invention.

FIG. 21a shows a flow chart of the operation of the main unit according to the present invention.

FIG. 21b shows a flow chart of the operation of the portable wireless card according to the present invention.

FIG. 21c shows a flow chart of the operation of the remote-control transmitter according to the present invention.

FIG. 21d shows a flow chart of subroutine operation of FIG. 21a.

FIG. 22 shows a block diagram showing the whole constitution of building door controlling system using radio communication according to the other embodiment of the present invention.

FIG. 23 shows a block diagram showing the constitution of the main unit of the building door controlling system according to the embodiment of FIG. 22.

FIG. 24 shows a block diagram showing the constitution of the wireless card of the building door controlling system according to the above embodiment.

FIG. 25 shows a time flow chart showing the signals that are transmitted during the operation of the building door controlling system according to the above embodiment and the wave form of the signals.

FIG. 26 shows a table showing wave form and the category of the signals that are transmitted during the operation of the building door controlling system and the demodulated signals according to the above embodiment.

FIG. 27 shows an exploded view of an embodiment of a building door locking unit according to the present invention.

FIG. 28a shows a front view of the building door locking unit according the other embodiment of the present invention.

FIG. 28b shows a side view of the locking unit illustrated in FIG. 28a.

FIG. 29 shows an exploded view of a locking unit in the door that is used with respect to the locking unit shown in FIG. 27.

FIG. 30a shows a block diagram of a locking unit in the door that is used with respect to the locking unit shown in FIGS. 28a and 28b according to other embodiment.

FIG. 30b shows a schematic side view of the locking unit shown in FIG. 30a.

FIG. 31 shows a schematic view showing that the door locking unit of the present invention is installed.

FIG. 32 shows a block diagram showing the constitution of a main unit of vehicle door/ignition controlling unit and the constitution of a portable wireless card according to other embodiment of the present invention.

FIG. 33 shows a block diagram showing the constitution of vehicle door/ignition controlling unit and the constitution of a portable wireless card according to other embodiment of the present invention.

FIG. 34 shows a flow chart showing the process of unlocking a door according to the embodiment in FIG. 32.

FIG. 35 shows a flow chart showing the process of unlocking a door according to the embodiment in FIG. 33.

### DETAILED DESCRIPTION OF THE PREFERRED EMBODIMENT

Referring to the attached drawings, the embodiments of a door controlling system using radio communication according to the present invention will be described in the following. A building door controlling system will be described firstly and then, a door controlling system of a vehicle will be explained thereafter. Even though the present specification states “a building door controlling system” for ease of explanation, as explained in the following, it should be noted that the technical constitution of the building door controlling system can be applied to various objects having door and is not limited to a building.

I. Building Door Controlling System

1. System Constitution

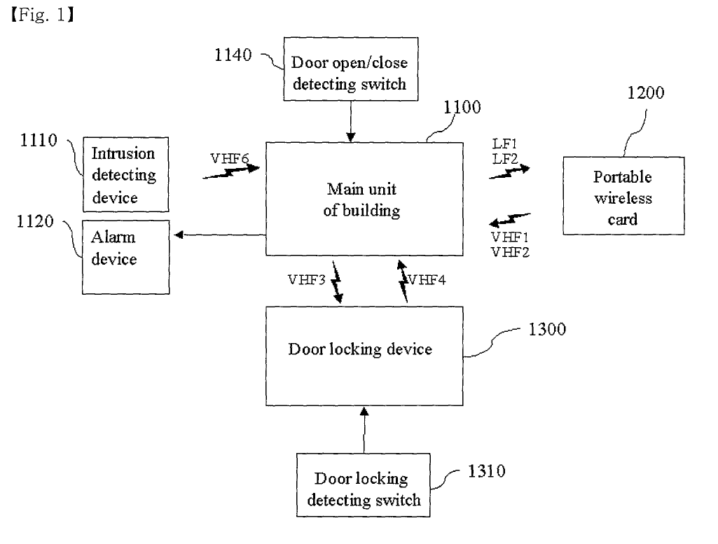

FIG. 1 shows a block diagram showing the entire constitution of a building door controlling system using radio communication according to the present invention.

As shown in FIG. 1, the building door controlling system comprises a portable wireless card (1200) which a user carries, a main unit (1100) for controlling various peripheral units wirelessly or wiredly by detecting whether portable wireless card (1200) approaches or not, and a door locking unit (1300) for controlling locking operation of the door according to the control of main unit (1100). Main unit (I 100) transmits synchronous signal to the surround, in a band of 100 KHz, for example, a band of LF.

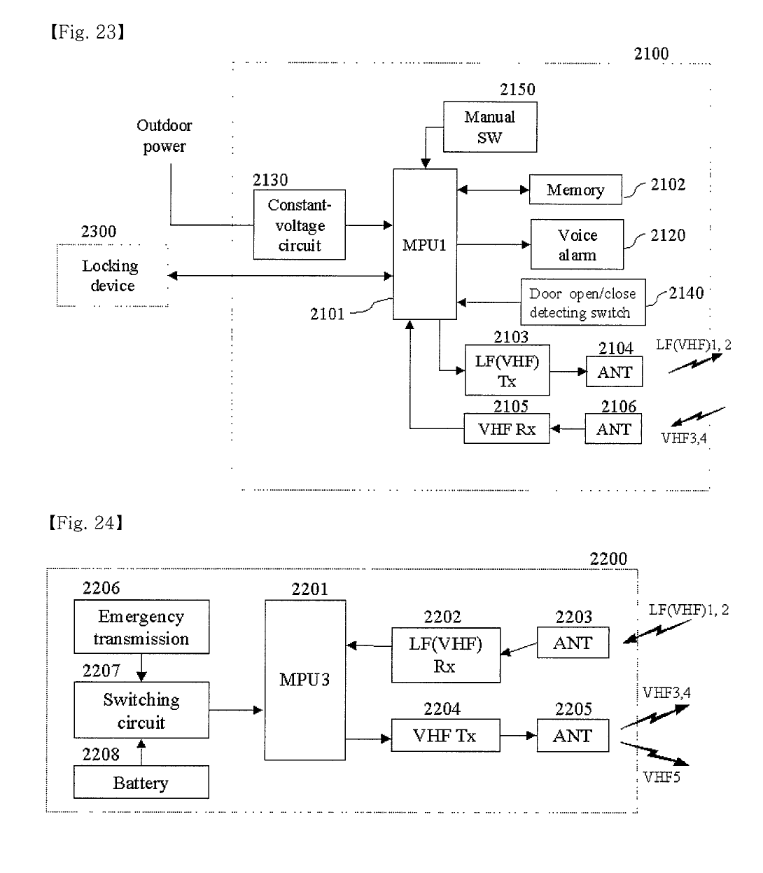

According to another embodiment of the present invention, it can be preferred to transmit synchronous signal with very high frequency instead of long wave, since the system operates only when a user turns on manual switch (2150). Even though, in the following, it is described that the main unit of the system that is operated only when manual switch (2150) is turned on, transmits long wave, it should be understood that the description includes the embodiment wherein the main unit transmits very high frequency. The main unit of the controlling system that is operated only when a user turns on manual switch (2150) is shown in FIG. 23.

Main unit (1100) transmits door locking command to door locking unit (1300) if a signal is not received from wireless card (1200) or if additional control is not performed, thereby maintaining the state where the door is locked. In this specification, this state is defined as an initial state.

Wireless card (1200) is located near main unit (1100). Upon receiving long wave that main unit (1100) transmits, the wireless card is turned on and transmits signal including ID code of the wireless card to main unit (1100). According to an embodiment of the present invention, the distance between wireless card (1200) and the main unit, which is criteria of determining whether wireless card (1200) transmits signal including ID code, is set to 1 m.

Main unit (1100) receives the signal that is transmitted by wireless card (1200) and decodes ID from the signal, and thereafter, determines whether there is stored ID code that is identical to the decoded ID. Main unit (1100) assumes that a user carrying effective wireless card (1200) approaches, if it is determined that the ID code of wireless card (1200) which is near main unit (1100) is identical to one of the stored ID codes, and transmits door unlocking command to door locking unit (1300). If it is determined that the ID code of the wireless card is not identical to any one of the stored ID codes, main unit (1100) returns to the initial state.

If wireless card (1200) terminates the transmission of signal including ID code since the card goes away from main unit (1100), main unit (1100) assumes that the user carrying wireless card (1200) moves to remote area since there is no signal received from wireless card (1200), transmits door locking command to door locking unit (1300), and thereafter, returns to the initial state. According to an embodiment of the present invention, the distance between the wireless card and the main unit, which is criteria of determining whether wireless card (1200) moves to remote area, is about 3 m.

Opening/closing detection switch (1140) is installed in a door. Opening/closing detection switch (1140) detects whether the door is opened or closed and reports it to main unit (1100), thereby enabling main unit (1100) to exactly recognize whether the door is opened or closed. Further, locking detection switch (1310) that is housed within door locking unit (1300) detects whether the door is opened or closed and reports it to door locking unit (1300), thereby enabling door locking unit (1300) to exactly recognize whether the door is locked or not. Using these techniques, locking operation can be controlled to perform without error.

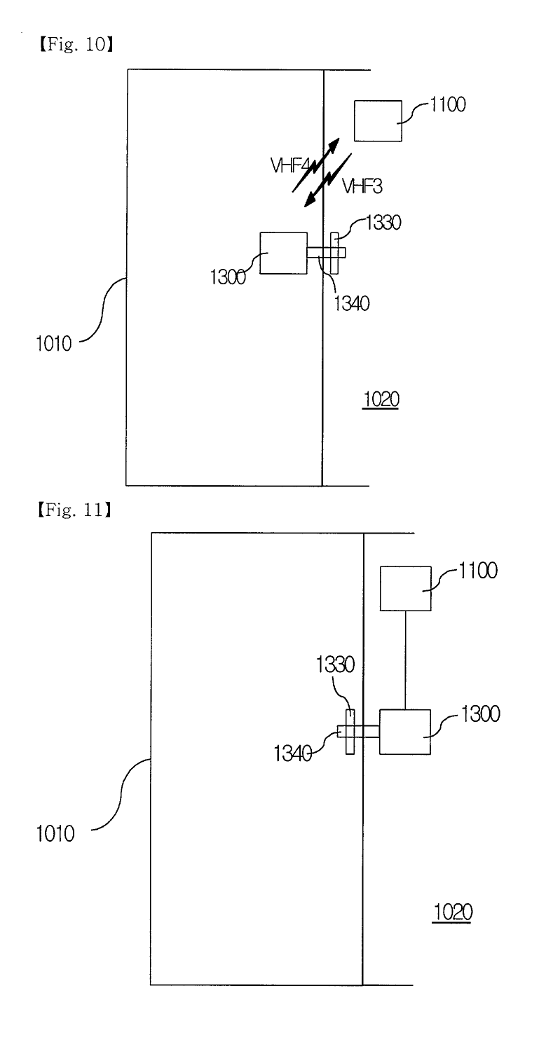

FIGS. 10 and 11 show conceptual drawings showing door locking unit (1300), locking detection switch (1310) and apparatus for locking the door. According to the embodiment shown in FIG. 10, door locking unit (1300) is provided in door (1010) in the structure wherein door (1010) is provided in an indoor wall or a doorframe (1020). Locking means for locking the door under the control of door locking unit (1300) comprises fixed member (1330) and engagement member (1340). Engagement member (1340) is made to protrude from door controlling unit (1300) and can move to the protruding position from door locking unit (1300) by the control of door locking unit (1300). Fixing member (1330) is provided in a wall or a doorframe (1020), has a hole to which engagement member (1340) is inserted and is formed in a position where engagement member (1340) can inserted into the hole as engagement member (1340) moves to a predetermined state. Door locking unit (1300) provided in door (1010) transmits third very high frequency (VHF 3) and fourth very high frequency (VHF 4) wirelessly to main unit (1100).

According to the embodiment of FIG. 11, door locking unit (1300) is provided in a wall or a doorframe (1020) in the structure wherein door (1010) is provided in an indoor wall or doorframe (1020). The embodiment of FIG. 11 differs from that of FIG. 10 in that door locking unit (1300) and engagement member (1340) are provided in doorframe (1020) and fixing member (1330) is provided in door (1010).

According to the embodiment of FIG. 11, since door locking unit (1300) is fixed in the wall or the doorframe, it is possible that the unit does not conduct radio communication with main unit (1100). Thus, door locking unit (1300) and main unit (1100) can exchange control signals by wire without transmitting and receiving the third very high frequency and the fourth very high frequency to each other.

Since it is possible to connect the door locking unit and the main unit by wire in the event that door locking unit (1300) is provided in the doorframe, the problem that a battery is used up for driving locking unit can be resolved. Further, it is possible to make the door design gracefully since the door locking unit is mounted in a door and the fixing member which is fixed by the locking unit is mounted in a door. It is also possible to unlock the locking unit by operating the fixing member that is mounted in the door without operating the locking unit when the door is opened and closed many times or when emergency occurs.

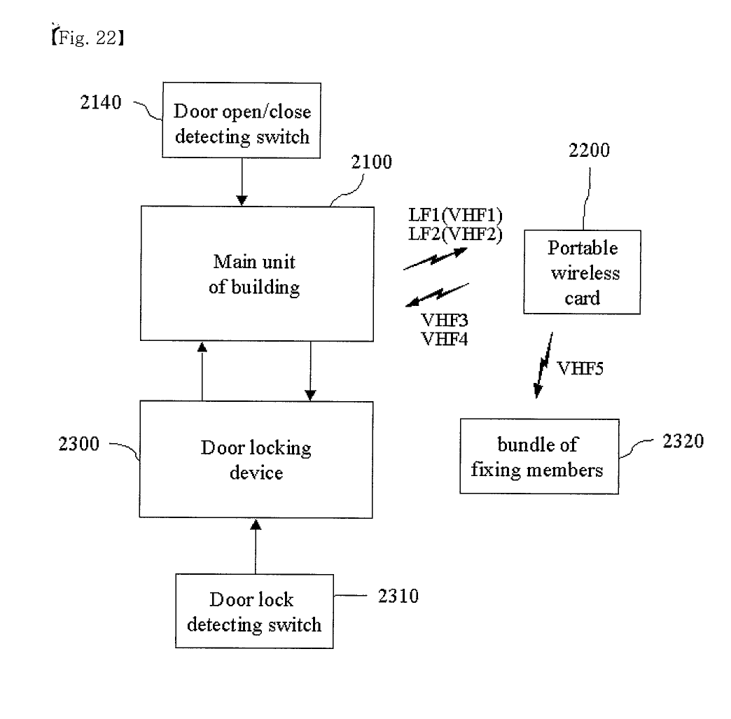

FIG. 22 shows a drawing of system constitution of the embodiment wherein door locking unit (2300) and main unit (2100) transmit and receive to each other by wire without perform radio communication.

The technical constitution of the door locking unit will be described in the following. Intrusion detecting unit (1110) and voice alarming unit (1120) are provided in indoor place of the building. Intrusion detecting unit (1110) is for detecting an object that intrudes the building without normally passing the door. According to an embodiment of the present invention, intrusion detecting unit (1110) can be constituted by movement detecting sensor and the like. Voice alarming unit (1120) is for coping with emergency situation by making alarm sound or informing the intrusion through telephone according to the control of main unit (1100).

Intrusion detecting unit (1110) detects the intrusion of an object which is not authorized and reports it by radio communication. Main unit (1100) makes voice alarm sound by controlling voice alarming unit (1120) after receiving, from intrusion detecting unit (1110), the report of the fact that an unauthorized object intrudes the building. Voice alarming unit (1120) notifies the intrusion fact by calling with the telephone number stored in the memory under the control of the main unit.

(1) Main Unit

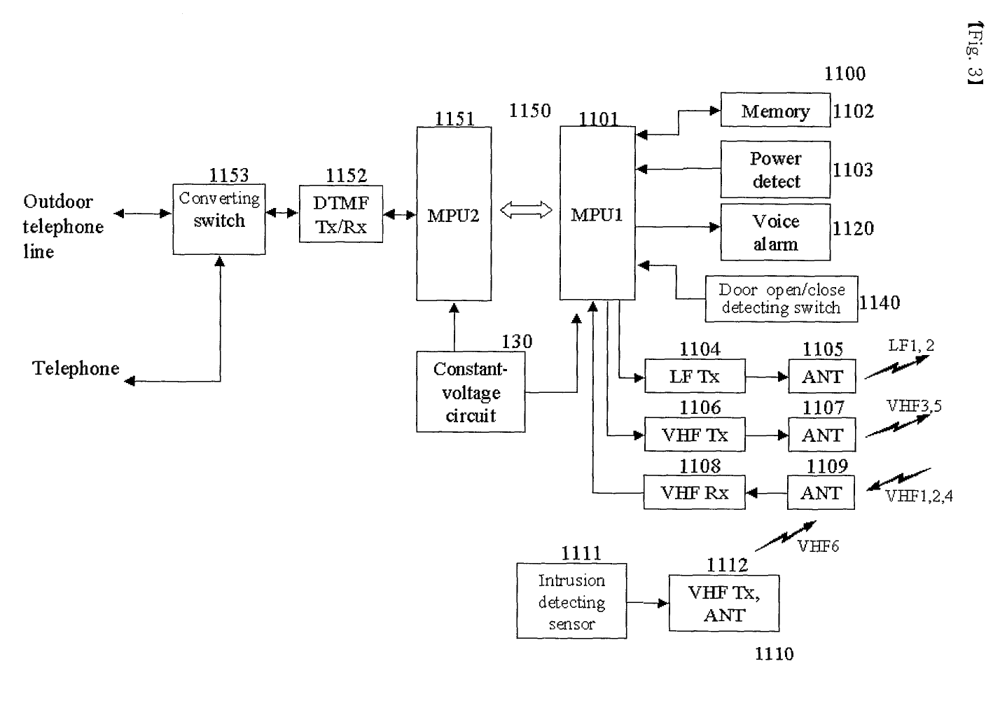

FIG. 3 shows a block diagram of the constitution of main unit (1100) in a building door controlling system using radio communication according to an embodiment of the present invention. Main unit (1100) of the embodiment of the present invention, comprises long wave generator (1104) for generating first and second long waves (LF1, LF2) including synchronous signal and long wave ID to be transmitted to wireless card (1200), and long wave antenna (1105) for transmitting the first and second long waves (LF1, LF2) which are generated in the long wave generator. Main unit (1100) further comprises a first very high frequency receiving antenna (1109) which receives the first and second very high frequencies (VHF1, VHF2) that are transmitted from wireless card (1200) and that includes ID code and door unlocking signal, and which receives a fourth very high frequency (VHF4) including door unlocking signal, locking operation signal, main stop signal and main operation signal from door locking unit (1300) and sixth very high frequency (VHF6) including intrusion signal from intrusion detection sensor (1110), and a first very high frequency transmitting antenna (1107) which transmits third very high frequency (VHF3) and fifth very high frequency (VHF5) including power control signal and characteristic code to controlling unit (1410).

Main unit (1100) has memory (1102). Memory (1102) memorizes at least one ID code for comparison and confirmation during communication with wireless card (1200) and telephone number for contacting outside through telephone controlling unit (1150) when intrusion is detected.

Main unit (1100) has an intrusion detection sensor (1110) such as movement detection sensor for detecting intrusion, power detector (1103) for detecting whether power reduces below a predetermined value, and voice alarming unit (1120) having voice chip for informing the current state by voice therein.

According to an embodiment of the present invention, main unit (1100) includes a first microprocessor (1101) for controlling each unit by receiving signals from the each unit. Main unit (1100) further includes telephone controlling unit (1150) for controlling home electronic appliances through telephone line, which is connected with outside telephone line. Telephone controlling unit (1150) has a converting switch (1153) that converts to outside telephone if telephone signal inputted through outside telephone line is not a control signal and that converts to DTMF transceiver circuit (1152) if it is determined that the telephone signal is control signal for controlling main unit (1100), DTMF (Dual Tone Multi Frequency) transceiver circuit (1152) that converts outside telephone input through converting switch (1153) to signal that is effective in a second microprocessor, the second microprocessor (1151) that receives controller designating signal and control signal from DTMF transceiver circuit (1152), analyzes and processes the signals and sends them to the first microprocessor (1101) and that receives to-be-called telephone number from first microprocessor (1101) when intrusion is detected and sends it to DTMF transceiver circuit. Preferably, first microprocessor (1101) and second microprocessor are connected to each other by serial port.

FIG. 23 shows a block diagram of main unit (2100) of building door controlling system wherein door locking unit (2300) and microprocessor (2101) of main unit (2100) communicate with each other by wire. For simplifying the drawing, telephone controlling unit for home automation and intrusion detection sensor and the like are not illustrated in FIG. 23. Main unit (2100) of FIG. 23 includes manual switch (2150) for turning on the system.

Main unit shown in FIG. 23 comprises long wave or very high frequency generator (2103) for generating first and second long wave (LF1, LF2) or first and second very high frequency (VHF1, VHF2) including synchronous signal and long wave ID or very high frequency ID that is to be transmitted to wireless card (2200), and long wave (very high frequency) antenna (2104) for transmitting the first and the second long wave (LF1, LF2) or the first and the second very high frequency (VHF1, VHF2) which are generated by the long wave or very high frequency generator. Main unit (2100) further comprises first very high frequency receiving antenna (2106) for receiving third and fourth very high frequency (VHF2, VHF4) that are transmitted by wireless card (2200) and that include ID code and door unlocking signal, and first very high frequency receiving unit (2105). Main unit (2100) is connected to door locking unit (2300) by wire and transmits/receives door locking signal and door unlocking signal.

Other constitutional elements operate as main unit (1100) shown in FIG. 3.

Main unit (1100, 2100) has a constant-voltage circuit (1130, 2130) that receives 220 V AC power and converts it to DC 5 V and DC 12 V through rectifier and smoothing circuit, thereafter supplying the converted DC power to main unit (1100, 2100).

(2) Wireless Card

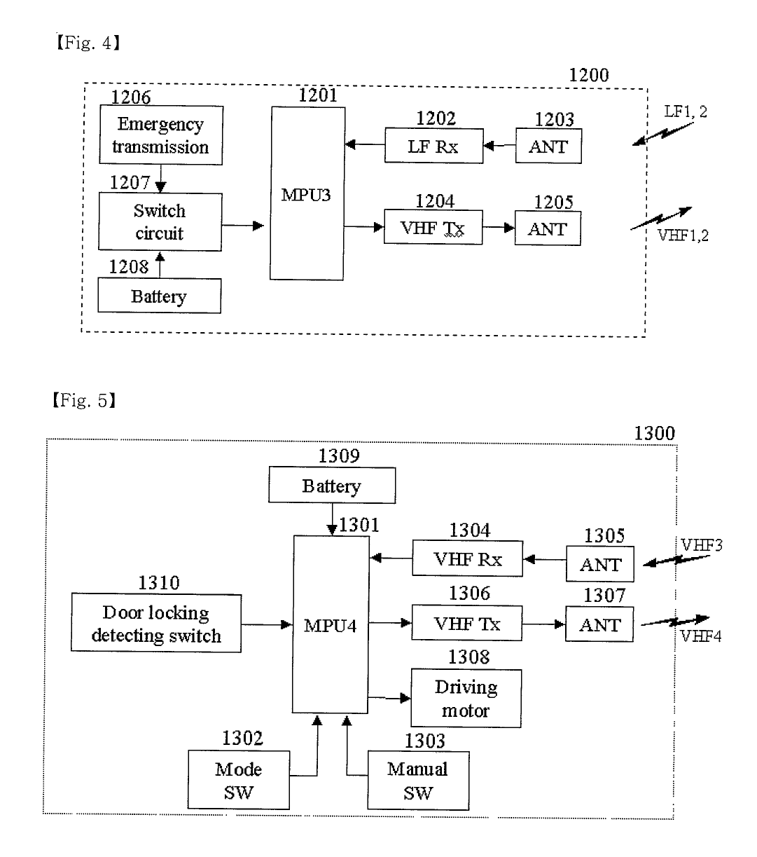

FIG. 4 shows a block diagram showing the constitution of wireless card (1200) according to the present invention. Wireless card (1200) comprises long wave receiving unit (1202) and long wave receiving antenna (1203) that are for receiving first long wave (LF1) including synchronous signal transmitted from main unit (1100) and for receiving second long wave (LF2) including long wave ID, second very high frequency receiving unit (1204) and second very high frequency transmitting antenna (1205) that are for transmitting first and second very high frequency (VHF1, VHF2) including characteristic data and door unlocking signal, card microprocessor (1201) for comparing and analyzing synchronous data and characteristic data that are received from long wave receiving unit (1202) and for outputting a predetermined characteristic data through second very high frequency transmitting unit (1204), switching circuit (1207) that is connected to card microprocessor (1201) and that supplies the power of battery (1208) to card microprocessor (1201) by the synchronous signal and emergency transmitting button (1206).

FIG. 24 shows a block diagram of wireless card (2200) according to the embodiment wherein a building door controlling system can be operated and can transmit signal for requesting lifting emergency only when a user turns on manual switch (2150). Wireless card (2200) comprises long wave (very high frequency) receiving unit (2202) and long wave (very high frequency) receiving antenna (2203) that are for receiving first long wave (LF1) or first very high frequency (VHF1) including synchronous signal transmitted from main unit (2100) and second long wave (LF2) including long wave ID or second very high frequency (VHF2) including long wave ID, second very high frequency transmitting unit (2204) and second very high transmitting antenna (2205) that are for transmitting, to main unit (2100), third and fourth very high frequency (VHF3, VHF4) including characteristic data and door unlocking signal, card microprocessor (2201) for comparing and analyzing synchronous and characteristic data received from long wave (very high frequency) receiving unit (2202) and for outputting a predetermined characteristic data through second very high frequency transmitting unit (2206), and switching circuit (2207) that is connected to card microprocessor (2201) and that supplies power of battery (2208) to card microprocessor (2201) by synchronous signal and emergency transmission button (2206).

Further, wireless card (2200) comprises emergency transmitting button (2206) which makes it possible to transmit fifth very high frequency (VHF5) including ID code and emergency unlocking signal when the door locking unit does not operate in an emergency situation.

FIG. 24 shows that wireless card (2200) receives long wave. However, it is preferred that the card receives very high frequency if manual switch (2150) is used. In latter case, long wave receiving unit (2202) and long wave receiving antenna (2203) should be changed to very high frequency receiving unit and very high frequency receiving antenna, respectively.

According to another embodiment of the present invention, the portable wireless card includes a sensor for detecting the movement of the wireless card. The sensor is made to operate only when the sensor detects the card movement, thereby minimizing exhaustion of battery of the portable wireless card. The object device controlling system which includes a sensor for detecting the movement of the portable wireless card will be described in the section describing a vehicle door controlling system.

(3) Door Opening/Closing and Locking Controlling Module

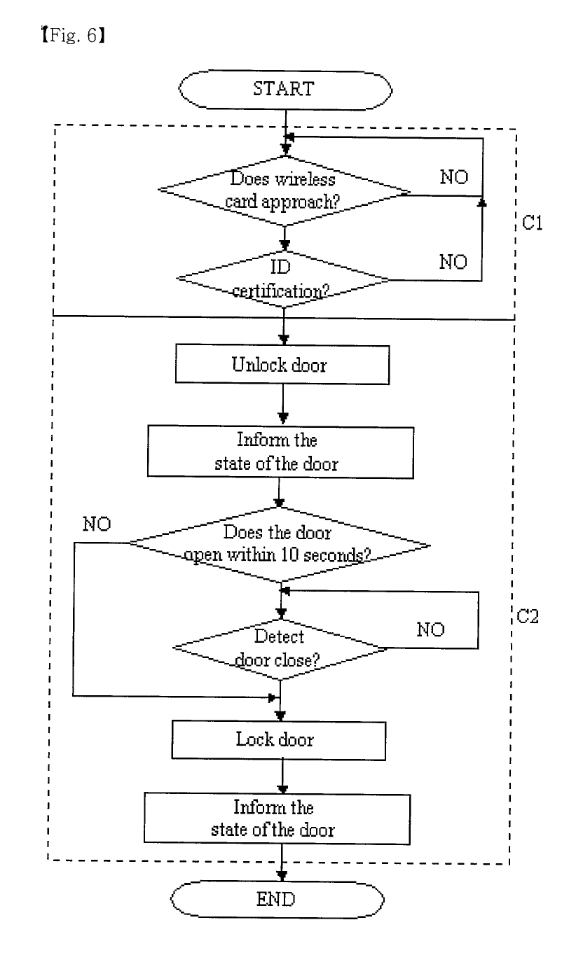

FIG. 5 shows a block diagram of door locking unit (1300) in a building watching and controlling system using radio communication according to the present invention. Door locking unit (1300) comprises second very high frequency receiving unit (1304) and second very high frequency receiving antenna (1305) that are for receiving third very high frequency (VHF 3) including unlocking signal transmitted from first very high frequency transmitting antenna (1107) and characteristic code and for sending the third very high frequency to microprocessor (1301) of door controlling unit, third very high frequency transmitting unit (1306) and third very high frequency transmitting antenna (1307) that are for transmitting fourth very high frequency (VHF 4) including door locking signal, unlocking signal or main stop signal, and main operating signal from microprocessor (1301) of the door controlling unit. Door locking unit (1300) further comprises microprocessor (1301) of the door controlling unit which analyzes door unlocking signal and drives driving motor (1308) connected to the output port, and which further transmits, to main unit (1100), the fourth very high frequency including signals inputted from various switches through transmitter (1306), and chargeable battery (1309) that supplies power to door controlling unit (1300) and that is connected to microprocessor (1301) of the door controlling unit.

Further, the locking module of the present invention comprises door opening/closing detecting switch (1140) for defining the opening/closing state of the door by detecting the current opening/closing state of the door and by sending the detection result to microprocessor (1301) of the door controlling unit, and door locking detection switch (1310) that is for making the operating driving motor (1308) to exactly stop in a designated position. Door opening/closing detecting switch (1140) is a magnetic switch or impact switch, and door locking detecting switch (1310) is preferably a contact switch. According to a preferred embodiment of the present invention, door opening/closing detecting switch (1140) is provided inside the main unit or is provided in a position so as to directly transmit/receive signal with the main unit. Further, as shown in FIG. 5, the door locking detection switch is installed inside door locking unit (1300) or is installed in a position so as to be able to transmit/receive signals with door locking unit (1300) directly.

According to an embodiment of the present invention, door locking unit (1300) further comprises mode switch (1302) for changing the door opening/closing mode to manual mode or automatic mode and manual switch for operating the door opening/closing manually when the mode is selected to a manual mode. In the event that passers frequently pass the door, the manual mode is useful, for example, when it is necessary to manually open/close the door using manual switch (1303) without performing automatic door opening by detecting whether wireless card (1200) exists or not. Further, the manual switch can be used for stopping main unit (1100) using mode switch (1302) or for unlocking the locking unit without carrying wireless card (1200).

If the mode switch is operated to manual mode, manual mode signal is inputted to microprocessor (1301) of the door controlling unit. The microprocessor of the door controlling unit transmits fourth very high frequency VHF4 including main stopping signal through third very high frequency transmitting unit (1306). Main unit (1100) stops upon receiving main stopping signal. According to the other embodiment of the present invention, main unit (1100) receiving main stopping signal can stop operation relating to the communicating function of the wireless card without stopping the whole operation of main unit (1100).

If the mode switch is operated to automatic mode, automatic mode signal is inputted to microprocessor (1301) of the door controlling unit. The microprocessor of the door controlling unit transmits fourth very high frequency VHF4 including main operating signal. Main unit (1100) resumes operation upon receiving main operating signal.

If the mode switch is operated to alarm mode, the locking unit of a door operates as the automatic mode when a person does not exist in the building. The alarm mode is used for detecting intrusion by operating intrusion detecting unit.

According to a preferred embodiment of the present invention, mode change of mode switch (1302) is possible after whether wireless card (1200) exists or not is checked. Thus, security can be improved.

(4) Door Locking Unit

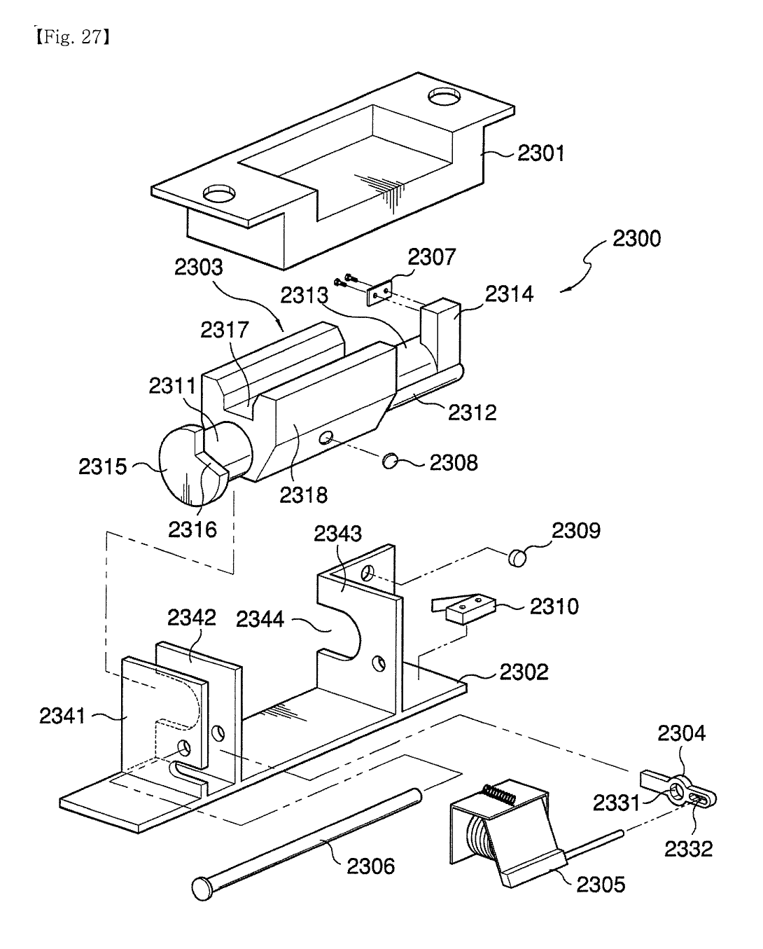

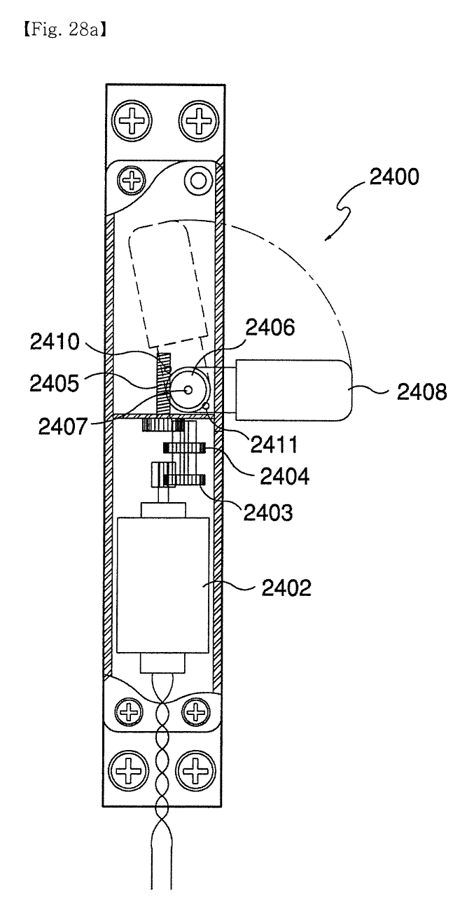

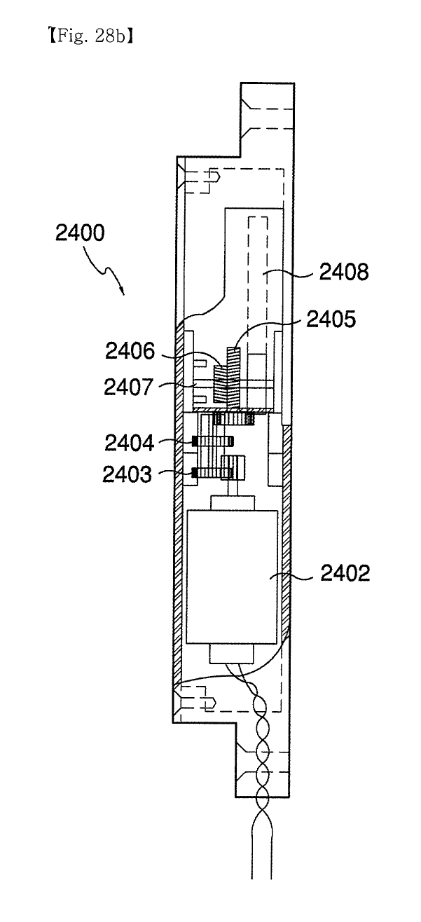

FIGS. 27 to 28a show the specific embodiments of door locking unit that is installed in a wall or door frame. FIG. 31 schematically shows that the door locking unit according to the present invention is installed. As shown in FIG. 31, main unit (2100) and door locking unit (2300) are connected by wire and the door locking unit (2300) is installed in a door frame.

In the following, a specific embodiment of door locking unit (2300) is described in detail with reference to the attached drawings.

1) First Embodiment

Referring to FIG. 27, a door locking unit (2300) consists of a driving unit and a locking unit. The driving unit comprises an engagement member (2304), a driving member (2303), and solenoid (2305). Driving member (2303) comprises a first axis (2311), a second axis (2313), a body (2318) and a flat portion (2315). Flat portion (2315) is provided with a groove where engagement member (2304) can be engaged, for example, a recess (2316) having a form of “ [symbol] .” The body (2318) of the driving member (2303) is provided with a longitudinal groove (2317). The locking unit comprises an upper case (2301), a lower case (2302) and a shaft (2306). As shown in the figure, shaft (2306) is inserted into a hole of lower case (2302) and passes through a first hole (2331) of the engagement member (2304) between a first wall (2341) and a second wall (2342). The axis of the solenoid is inserted into a second hole (2332) of engagement member (2304).

The first and second axes (2311, 2313) of the driving member (2303) are rotatably fitted to an approximate “U”shaped groove (2344) of the second wall (2342) and a third (2343) of the lower case (2302).

In the event that the door is locked, driving member (2303) cannot be rotated since engagement member (2304) is engaged in recess (2316) with “ [symbol] ” shape that is provided in flat portion (2315). Further, in that state, since fixing member (2352) of the door is engaged with groove (2317) of driving member (2303) and since the rotation of driving member (2303) is prevented by engagement member (2304), the door does not open.

When an unlocking signal is received from main unit (2100), solenoid operates to rotate engagement member (2304). Since the engagement between engagement member (2304) and recess (2316) of flat portion (2315) of driving member (2303) is unlocked by the rotation of engagement member (2304), driving member (2303) can rotate. Next, when the door is pushed or pulled, the driving member can rotate clockwise by fixing member (2352) of the door, and thus, the door opens.

If fixing member (2352) is removed by the rotation of driving member (2303), driving member (2303) can return to the initial state by a return spring of solenoid (2305) and the reaction of driving member (2303). In order to prevent this, magnet (2308) that can be attached to shaft (2306) is provided beneath the driving member, thereby maintaining the opening state before driving member (2303) that rotates is closed by fixing member (2352) mounted in the door.

When the rotation of driving member (2303) opens the door, a door locking switch (2310) is released by protruding portion (2312) of driving member (2303) so that signal indicating that the door opened is transmitted to main unit (2100).

On the other hand, fixing member (2352) simultaneously rotates upon door's closing. At this time, the rotating fixing member (2352) pushes driving member (2303) attached to shaft (2306) and engagement member (2304) rotates to the initial state by the return spring of solenoid (2305). Driving member (2303) is fixed by engagement member (2304) as described in the above.

When driving member (2303) returns to the initial state, door locking switch (2310) operates by protruding portion (2312) of driving member (2303) and the signal indicating that the door is closed is transmitted to main unit (2100).

In the event that driving member (2303) returns to the initial state, it is fixed by magnet (2309) and plate (2307) that are provided in lower case (2302) in order to prevent driving member (2303) from moving due to mechanical tolerance.

In this embodiment, almost whole of locking device (2300) is manufactured from nonmagnetic materials such as aluminum and the like, while shaft (2306) and plate (2307) are manufactured from magnetic material such as steel and the like.

Further, the door can rotate if solenoid (2305) operates by unlocking signal of main unit (2100). If the door does not open within a predetermined time for example, four seconds, solenoid (2305) returns to the initial state and locks driving member (2303). If the door opens within a predetermined time, driving member (2303) rotates to be attached to shaft (2306) by magnet (2308) provided in driving member (2303), and thus, unlocking state is maintained. If driving member (2303) returns to the initial state by the close of the door, since driving member (2303) is fixed by magnet (2309) provided in lower case (2302), driving member (2303) is prevented from minutely rotating and thus, locking state is maintained.

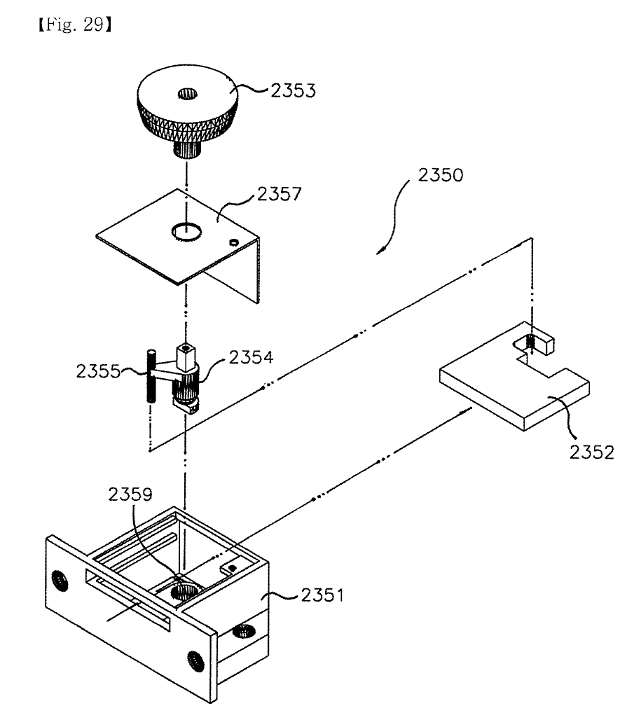

The above description relates to the operation of the locking device by unlocking signal of main unit (2100). When the locking device is damaged by, for example, fire, it is possible to operate the fixing member that is provided in the door in the following without repeating the above operations. FIG. 29 shows the fixing member of the door according to the present invention.

A door can be freely opened by removing the protruding portion that is fixed to the driving member by operating the fixing member that is locked by driving member (2303) of door locking unit (2300).

A bundle of fixing member (2350) that is mounted in a door is maintained in the locking state by fixing member (2352) being inserted into the groove of driving member (2303). In emergency, for example, when the locking device is damaged due to fire, or when it is convenient to manually unlock the locking device due to frequent entrance and exit, fixing member (2352) can be moved to the inside of bundle of fixing member (2350) by operating manual lever (2353).

The detailed description to the above embodiment is as follows. Pulling manual lever (2353) in order to move the fixing member moves rotating axis (2354) that maintains its position by holding spring (not shown) to upper position where the rotating axis can rotate, from the position where the rotating axis cannot rotate since it is engaged with groove (2359) of case (2351). In the upper position, rotating manual lever (2353) makes protruding portion (2355) of rotating axis (2354) to rotate and move fixing member (2352) engaged with the protruding portion (2355) to the inside of the bundle of fixing member (2350), thereby setting unlockable state.

In the conventional locking device, the above operation can be achieved by two step operation consisting of an operation for making the manual lever to rotatable state by operating a separate locking means provided behind a locking device and then, and an operation for changing the locking state of the locking device by operating the manual lever. However, according to the present invention, since only one manual lever is necessary, it is more convenient to use.

2) The Second Embodiment

FIGS. 28a and 28b show the second embodiment of the door locking unit according to the present invention. Compared to the first embodiment using the solenoid, the second embodiment uses motor (2402), a first and a second flat gears (2403, 2404) and worm gears (2405, 2406). The locking device (2400) of the second embodiment comprises motor (2402), flat gears (2403, 2404), worm gears (2405, 2406), driving member (2408) and door locking switches (2410, 2411). The locking device (2400) is mounted in a doorframe (2401).

The first flat gear (2403) is engaged with the output axis of motor (2402). The first flat gear (2403) engages the second flat gear (2404). First and second gears (2404, 2405) are provided with a means (not shown) for making second flat gear (2405) to rotate after first gear (2403) idles for one rotation when motor (2402) operates. Second gear (2404) engages worm gear (2405).

The operation of door locking unit (2400) is as follows. When motor (2402) receives unlocking signal to operate, first flat gear (2403) that engages the motor starts to rotate. At this time, first flat gear (2403) idles for one rotation and thereafter, engages second flat gear (2404) to transmit the rotation. Subsequently, worm gear (2405) that engages second flat gear (2404) rotates to rotate driving member (2408). As shown in FIG. 28a, driving member (2408) counterclockwise rotates when the door opens. However, it is also possible that the driving member clockwise rotates.

As described in the above, two gears of the first and second flat gears (2403, 2404) wherein the second flat gear (2404) rotates after the first flat gear (2403) idles for one rotation are used in order to reduce load on the motor caused by initial rotation by transmitting the motor power to worm gear (2405) after one idling, without directly transmitting the power to the worm gear.

Further, it is possible to use other kind of gears without using worm gear (2405). However, since the rotating velocity of driving member (2408) is much slow compared to the rotating velocity of motor (2402), it is somewhat difficult to combine only flat gears conforming to such a velocity ratio. Thus, it is preferred to use a worm gear as the present embodiment. This is because a worm gear can provide high reduction gear ratio.

Two-step stop signals are inputted for the stop position of driving member (2408). The motor stop position is designated by turning on the motor on proper time according to an experiment. When locking detection switches (2410, 2411) commands that the position of driving member (2408) is locking or unlocking state, this signal is inputted to main unit (2100) and turns off the motor, with informing the state of the locking device by, for example, voice.

A contact switch or photo sensor can be used for door locking switch (2410, 2411).

When driving member (2408) counterclockwise rotates to locate in a predetermined position, the position of driving member (2408) is detected by position detecting sensor (2401) and the signal that the door opens is transmitted to main unit (2100).

Engagement member having a form of “ [symbol] ” that can be engaged with driving member (2408) in the door although it is not shown.

Motor (2402) starts to rotate in the counter direction to the rotating direction when the door is opened, if a door locking signal is received from main unit (2100). Driving member (2408) returns to the initial locking position by the power transmission of flat gears (2403, 2404) and worm gears (2405, 2406). When driving member (2408) returns to the initial position, the position is detected by position detecting sensor (2411) and a signal indicating that the door returns to its locking position is transmitted to main unit (2100).

According to the present invention, if the door locking unit cannot be unlocked by the above-described operations, that is, if driving member (2408) does not rotate even if the motor driving signal is inputted since mechanical trouble occurs in the main unit or the locking device, the door locking unit is unlocked as follows.

If fifth very high frequency (VHF5) including emergency unlocking requesting signal is received by very high frequency receiving antenna (2327) and receiving unit (2326), ID code included in fifth very high frequency (VHF5) is extracted and is compared with the ID code stored in memory (2325). If the ID codes are identical to each other, solenoid (2328) is operated, thereby maintaining the normal state by holding means (2323). Cover (2322) with which the driving member is engaged slides downwardly and is removed, thereby unlocking the locking device. The holding means can be holding spring.

Fixing member (2320) having the emergency unlocking function as described in the above comprises a chassis (2321) for fixing the driving member, a cover (2322) that slides in emergency time, holding means (2323) for holding, receiving antenna (2327) and receiving unit (2326) that are for receiving fifth very high frequency (VHF5) including emergency unlocking requesting signal from a wireless card, memory (2325) for storing ID code, microprocessor (2324) that is for receiving the fifth very high frequency, analyzing it and operating solenoid (2328) mounted in an output port, solenoid (2328) for moving cover (2322) held by the holding means according to the output of microprocessor (2324), and a battery (2329) for supplying power to the microprocessor (2324) of the fixing member and the solenoid (2328).

When fifth very high frequency (VHF5) including an emergency unlocking requesting signal is received, solenoid (2328) operates, thereby releasing the engagement between cover (2322) and holding means (2323). Thus, cover (2322) moves downwardly and the fixing member is unlocked. Thus, the door can be unlocked in the emergency.

(5) Control Module of Home Electronic Appliances

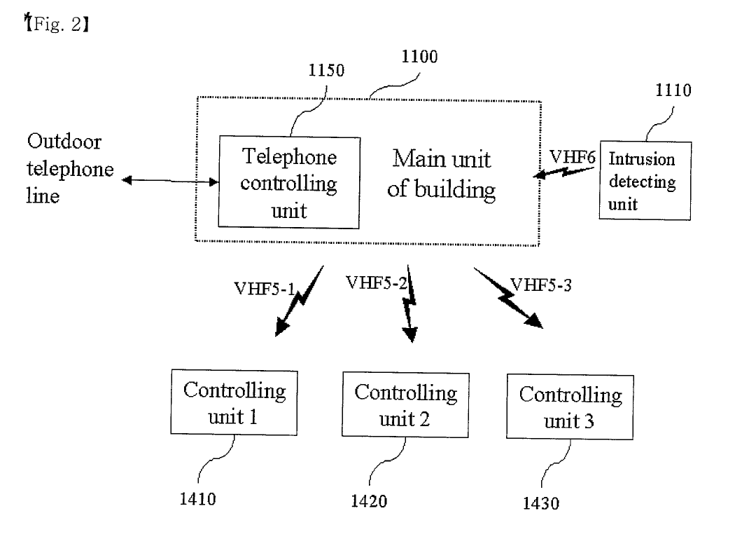

FIG. 2 shows a block diagram for the indoor home electronic appliances that are controlled in the outside, using the building watching and controlling system which uses radio communication according to an embodiment of the present invention.

According to the present invention, the power of indoor home electronic appliance can be controlled using outside telephone line. The system for performing this function comprises telephone controlling unit (1150) that is for receiving telephone signal including control code and controlling unit designating signal from outside telephone line and for outputting the control code and the controlling unit designating signal to main unit (1100), main unit (1100) that is for receiving the control code and the controlling unit designating signal from telephone controlling unit (1150) and, for, based on the inputted signal, transmitting fifth very high frequency (VHF5-n) including control signal and characteristic code to home electronic home appliance controlling unit, and controlling units (1410, 1420, 1430) that is for receiving the fifth very high frequency (VHF5-n) from main unit (1100).

It is preferred that the controlling units (1410, 1420, 1430) are provided in each of home electronic appliances.

For example, controlling unit (1410) of plug type can be used by directly connecting with an electronic appliance. Further, controlling unit (1410) receives fifth very high frequency (VHF5-1) transmitted from main unit (1100) and can turn on/off the power according to the control signal included in the received signal.

The system according to the present invention comprises wireless intrusion detecting unit (1110). If intrusion detecting unit (1110) detects that somebody intrudes, the unit transmits sixth very high frequency (VHF6) including the intrusion detecting signal. Main unit (1100) receiving the sixth very high frequency (VHF6) operates voice alarm device (1120), with transmitting telephone number and alarm message stored in the memory of main unit (1100) through telephone controlling unit (1150). Further, main unit (1100) can be constituted so as to calls with the received telephone number and providing the alarm message.

In the present embodiment, telephone controlling unit (1150) has telephone line connected thereto and wirelessly controls indoor home electronic appliances using very high frequency according to the direction received through telephone line. Therefore, it is very convenient compared to the conventional home automation system since additional wiring is unnecessary and installation is easy.

2. System Operation

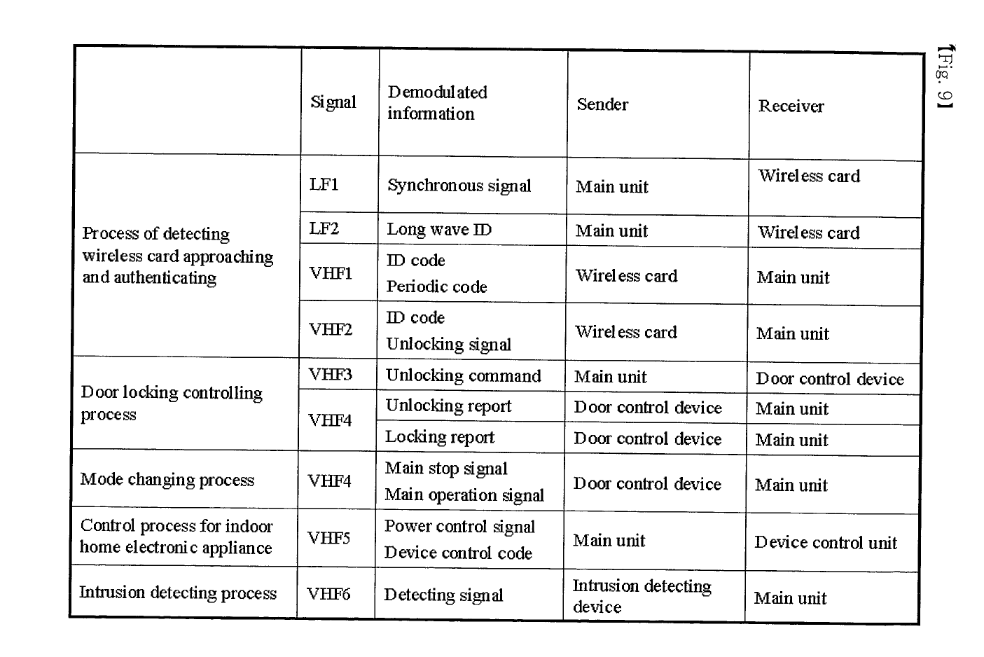

FIG. 6 shows a flowchart explaining the operation of building watching and controlling system according to the present invention. FIG. 8 shows time flowchart showing waveform and signals that are transmitted during the operation of building watching and controlling system according to the present invention. FIG. 9 shows a table showing waveform, category of signals and demodulated signal that are transmitted during the operation of building watching and controlling system according to the present invention.

The operation of the building watching and controlling system using radio communication shown in FIG. 1 will be described in the following with reference to FIGS. 6, 8 and 9.

(1) Wireless Card Approach Detecting and Authenticating Process (C1)

Main unit (1100) mounted indoors periodically transmits first long wave including synchronous signal for detecting wireless card (1200) approach.

When a user carrying wireless card (1200) approaches main unit (1100), for example, within 1 m from the main unit, wireless card (1200) receives the first long wave (LF1). Wireless card (1200) receiving the first long wave turns on the indoor power circuit.

Wireless card (1200) transmits first very high frequency (VHF1) of 80 bits including ID code. In this process, wireless card (1200) generates period code in random mode with being synchronized with first long wave (LF1). Next, wireless card (1200) loads the characteristic data stored in a channel in the period code and transmits it as the first very high frequency (VHF1). For example, the ten channels where wireless card (1200) transmits the characteristic data are provided and one channel among the ten channels can be selected.

According to a preferred embodiment of the present invention, wireless card (1200) generates new code such as period code, mode code and checksum bit in addition to the ID code of 32 bits, which are called here as “ALLFREE CODE.” Further, according to a preferred embodiment of the present invention, the period can be varied by random mode and thus, it is prevented that the signal is repeatedly transmitted with the same period.

Main unit (1100) receives first very high frequency (VHF1) transmitted from wireless card (1200) and extracts ID code therefrom. Next, the extracted ID code is compared with the ID code stored in the memory. This is referred to as “first ID certification.” In the first ID certification, if they are identical, main unit (1100) transforms the period code among the signals included in the first very high frequency (VHF1) into long wave ID, and transmits the second long wave (LF2) including it. If they are not identical, it returns to the door locking state, i.e., the initial state.

Wireless card (1200) compares long wave ID carried on the second long wave (LF2) with the period code generated in random mode when the first very high frequency is transmitted. This is referred to as “second ID certification.” In the second ID certification, if they are identical, second very high frequency (VHF2) including ID code and unlock requesting signal is transmitted. Next, the card is changed into a standby state and maintaining only long wave receiving circuit as being turned on. In the standby state, only long wave receiving circuit operates and detects whether long wave is received or not. Thus, very low current of dozens of μA is consumed.

As described in the above, wireless card (1200) generates new period code, transmits it, and compares the generated period code with the long wave ID included in the second long wave (LF2) received from main unit (1100) whenever the card transmits the first very high frequency (VHF1), thereby reducing the danger of ID exposure. Further, according to the present invention, the communication between main unit (1100) and wireless card (1200) repeats two times, and thus, it is possible to operate the system without being affected by outside noise. Further, technique of preventing interference disclosed in Korean Patent Application No. 10-2000-62028 filed on Oct. 20, 2000, which is incorporated herein by reference, can be used in order to prevent interference by the same frequency.

Main unit (1100) receives the second very high frequency (VHF2) transmitted from wireless card (1200), and thereafter, compares once again the ID code included in the second very high frequency (VHF2) with the ID code stored in the memory of main unit (1100). This is referred to as “third ID certification.” In the third ID certification, if they are identical, main unit (1100) transmits third very high frequency (VHF3) including unlocking command to door locking unit (1300).

As described in the above, main unit (1100) and wireless card (1200) certify ID code three times by bilateral communication.

According to a preferred embodiment of the present invention, time lag between signal receiving and response signal receiving of main unit (1100) and wireless card (1200) is calculated. And the time lag should be controlled so as not to exceed a predetermined time. Thus, the bilateral communication is completed within the predetermined time, thereby improving reliability of authenticating process.

Wireless card approach detecting and authenticating processes of building door controlling system that operates only when manual switch (2150) is turned on will be described in the following.

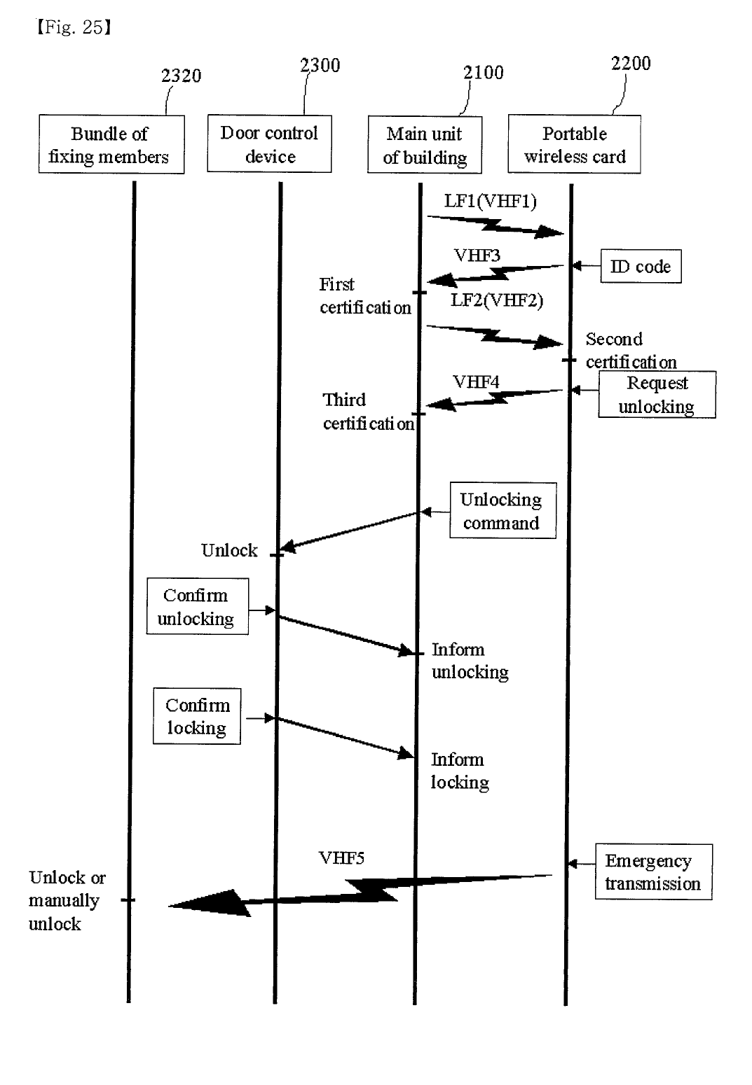

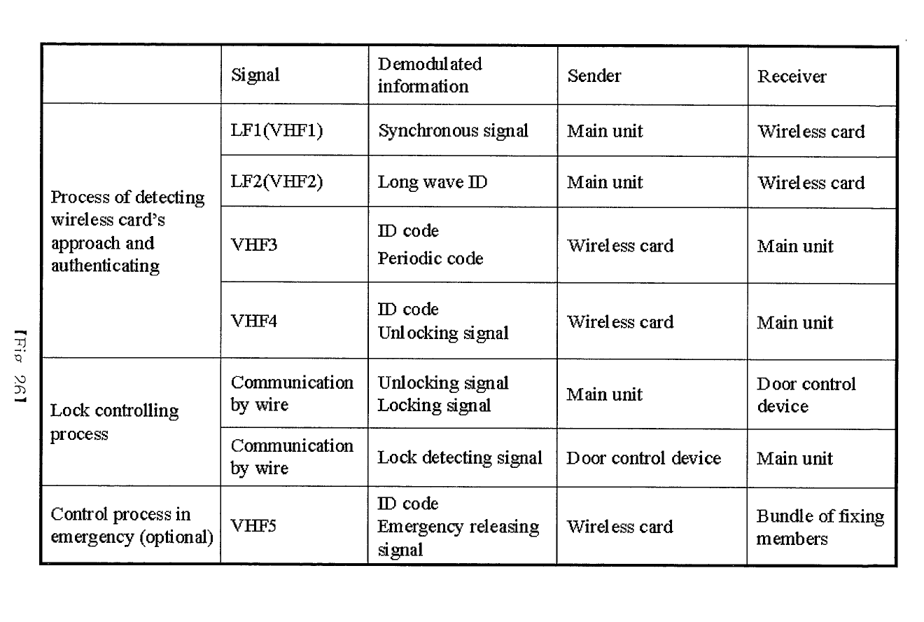

The time flowchart of this embodiment is shown in FIG. 25. The processes will be described with reference to FIG. 25.

When a user turns on manual switch (2150), main unit (2100) installed indoors periodically transmits first long wave (LF1) or first very high frequency (VHF1) that include synchronous signal in order to detect wireless card (2200) approaching. If manual switch (2150) is in off state, the object device controlling system according to the present invention does not operate and maintain the standby state.

If the user carrying wireless card (2200) approaches main unit (2100), for example, if the user approaches within 1 m from the main unit, wireless card (2200) receives the first long wave (LF1) or the first very frequency (VHF1). Upon wireless card (2200)'s receiving the first long wave (LF1) or the first very high frequency (VHF1), the indoor power circuit is turned on.

Wireless card (2200) transmits third very high frequency (VHF3) of 80 bits including ID code. In this process, wireless card (2200) generates period code in random mode with being synchronized with the first long wave (LF1). Next, wireless card (2200) loads the characteristic data stored in a channel in the period code and transmits it as the third very high frequency (VHF3). For example, the ten channels where wireless card (2200) transmits the characteristic data are provided and one channel among the ten channels can be selected.

According to a preferred embodiment of the present invention, wireless card (2200) generates new code such as period code, mode code and check sum bit in addition to the ID code of 32 bit, which are called as “ALLFREE CODE.” Further, according to a preferred embodiment of the present invention, the period can be randomly varied and thus, it is prevented that the signal is repeatedly transmitted with the same period.

Main unit (2100) receives the third very high frequency (VHF3) transmitted from wireless card (1200) and extracts ID code therefrom. Next, the extracted ID code is compared with the ID code stored in the memory. This is referred to as “first ID certification.” In the first ID certification, if they are identical, main unit (2100) compares the period code among the signals included in third very high frequency (VHF3) with the period code randomly generated when the third very high frequency is transmitted. This is referred to as “second ID certification.” In the second ID certification, if they are identical, fourth very high frequency (VHF4) including ID code and unlocking requesting signal is transmitted. Next, the card becomes a standby state and maintains only long wave (very high frequency) receiving circuit as being turned on. In the stand-by state, only long wave receiving circuit operates and detects whether long wave is received or not. Thus, very low current of dozens of μA is consumed.

As described in the above, wireless card (2200) generates new period code, transmits it, and compares the generated period code with the long wave ID included in the second long wave (LF2) or the second very high frequency (VHF2) received from main unit (2100) whenever the card transmits the first very high frequency (VHF1), thereby reducing the danger of ID exposure. Further, according to the present invention, the communication between main unit (2100) and wireless card (2200) repeats two times, and thus, it is possible to operate the system without being affected by outside noise. Further, interference preventing technique disclosed in Korean Patent Application No. 10-2000-62028 filed on Oct. 20, 2000, which is incorporated herein by reference, can be used in order to prevent interference due to the same frequency.

Main unit (2100) receives fourth very high frequency (VHF4) transmitted from wireless card (2200), and thereafter, compares once again the ID code included in fourth very high frequency (VHF4) with the ID code stored in the memory of main unit (2100). This is referred to as “third ID certification.” In the third ID certification, if they are identical, main unit (1100) transmits unlocking requesting command to door locking unit (2300).

As described in the above, main unit (1100) and wireless card (1200) certify ID code three times by bilateral communication.

According to a preferred embodiment of the present invention, time lag between signal receiving and response signal receiving of main unit (2100) and wireless card (2200) is calculated. And the time lag should be controlled so as not to exceed a predetermined time. Thus, the both directional communication is completed within the predetermined time, thereby improving reliability of authenticating process.

(2) Door Locking Control Process (C2)

As described in the above, when the process for authenticating approaching person is completed and when it is confirmed that effective wireless card (1200) approaches, main unit (1100) transmits third very high frequency (VHF3) including unlocking requesting command.

Door locking unit (1300) receives third very high frequency (VHF3) transmitted from main unit (1100) and drives the driving means such as motor (2402) or solenoid (2305) that is mounted in the door locking means, thereby unlocking the door. At this time, door locking detection switch (1310) is provided for defining the door locking position by driving of motor of the door locking means. Explaining in detail, when door locking detection switch (1310) detects unlocking state, motor (2402) or solenoid (2305) stops, thereby preventing overload to the motor.

When the door locking means is unlocked, door locking unit (1300) transmits fourth very high frequency (VHF4) including unlocking confirming signal. If the main unit and the door locking unit are connected by wire to each other, the unlocking confirming signal is sent by wire to the main unit. Main unit (1100) receives fourth very high frequency (VHF4) to confirm the door unlocking state. According to an embodiment of the present invention, main unit (1100) informs the door unlocking state with voice. After the door is unlocked, door open/close detecting switch (1140) installed in the door detects whether the door is opened by the user and reports it to main unit (1100).

In the unlocking state, if door open/close detecting switch (1140) reports that the door is not opened within a predetermined time, door locking unit (1300) automatically closes the door and main unit (1100) outputs door locking message through speaker. According to an embodiment of the present invention, the predetermined time set forth ten seconds.

In the unlocking state, if door open/close detecting switch (1140) reports that the door is opened within a predetermined time, opening state is maintained. However, if door open/close detecting switch (1140) reports that the door is closed, main unit (1100) determines whether wireless card (1200) is near location. If it is determined that wireless card (1200) does not exist, door locking unit (1300) drives a motor installed in the locking means to lock the door. Next, door locking detection switch (1310) detects the door locking, door locking unit (1300) stops the motor, thereby preventing the motor from being over loaded.

If the locking device operates, the door locking signal transmits fourth very high frequency (VHF4) including locking signal. The main unit receives the signal to inform through speaker that the door is closed.

On the other hand, when wireless card (1200) goes away more than a predetermined distance for example, 3 m, from the building or main unit (1100), the communication between main unit (1100) and wireless card (1200) stop. In this case, main unit (1100) returns to the initial state and transmits door locking command to door locking unit (1300). Therefore, the door is automatically locked without additional locking operation, for example, when a user goes out.

According to a preferred embodiment of the present invention, key holder or detecting unit does not have to be installed outside the door since almost every communication is wirelessly performed. Thus, it is impossible to recognize from the outside of the building where door locking unit (1300) or door locking means is installed. Therefore, it is more difficult for a third party to destroy door locking unit (1300).

According to the present invention, almost data communication between wireless card (1200) and main unit (1100) is wireless data communication. Since authenticating process of authenticating whether wireless card (1200) is effective or not is conducted, even if wireless card (1200) except the effective wireless card (1200) approaches, it cannot release main unit (1100) or other devices from the initial state, i.e., locking state. Therefore, if wireless card (1200) that is registered with respect to main unit (1100) is not carried out, the door cannot be unlocked or opened.

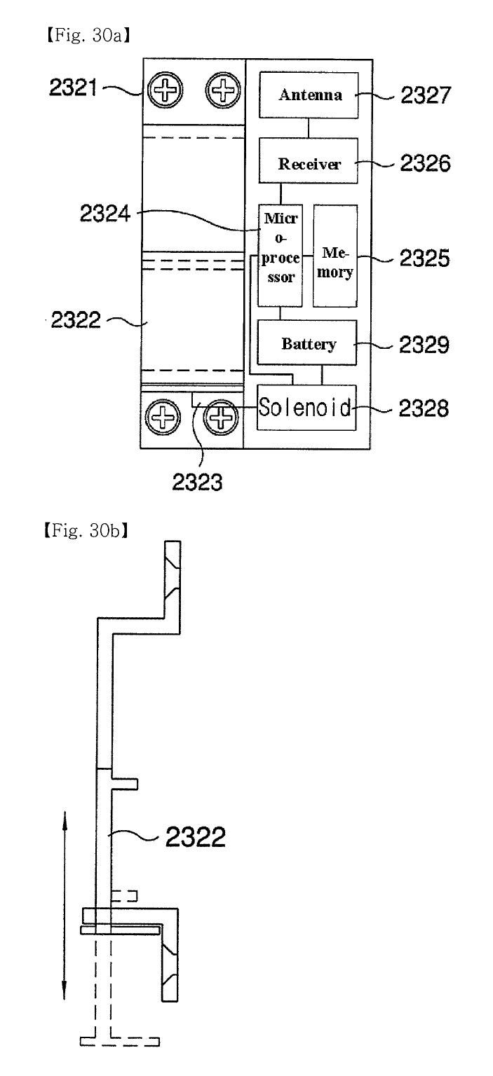

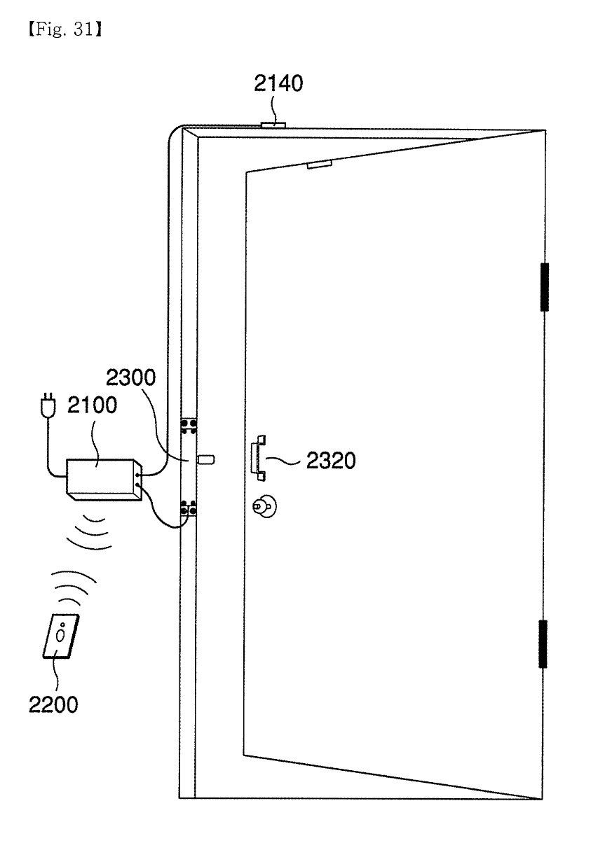

The building door controlling system shown in FIGS. 22 to 31 conducts the door locking processes as described in the above.

(3) Indoor Home Electronic Appliance Controlling Process

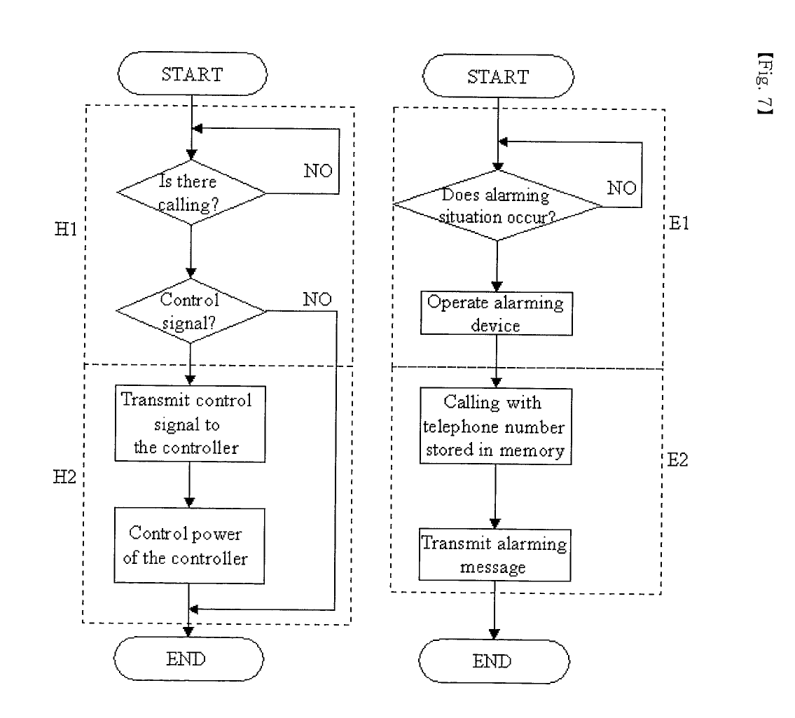

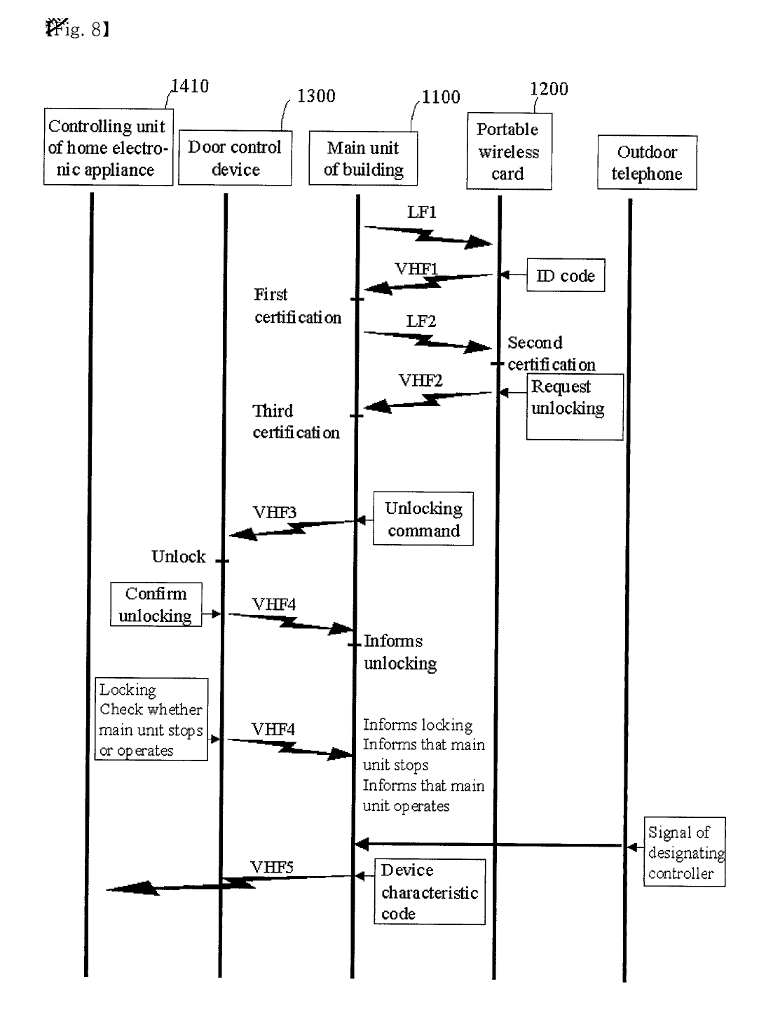

FIG. 7 shows a flowchart for the process of controlling indoor home electronic appliance using building watching and controlling system which is comprised of main unit (1100) of the building, telephone controlling unit (1150), home electronic appliance controlling unit (1410, 1420, 1430) and wireless intrusion detecting unit (1110).

When a user calls telephone controlling unit (1150) by telephone to input control signal, telephone controlling unit (1150) performs control signal certifying process of certifying whether the inputted signal is according to pre-selected format (H1).

If it is determined that the inputted signal is general voice signal, not a signal that is according to pre-selected format, converting switch (1153) converts the mode to general telephone mode. Next, the general telephone communication is performed.

If it is determined that the inputted signal is signal that is according to pre-selected format, the process goes to home automation mode and performs control process (H2) of controlling unit.

In home automation mode, DTMF transmitting unit (1152) converts control signal and controller designating signal among the inputted signal into digital signal. Second microprocessor (1151) processes the digital signal that is from DTMF transmitting unit (1152), and transmits the processed digital signal to first microprocessor (1101) through serial port. Main unit (1100) converts controller designating signal into device characteristic code. Next, the main unit transmits fifth very high frequency (VHF5) including power controlling signal and device characteristic code.

Each of home electronic appliance (1410, 1420, 1430) installed in receptacle receives fifth very high frequency (VHF5) transmitted by the main unit, confirms the device characteristic code, and thereafter, turns on/off the power according to the power controlling signal.

Further, the present device can perform intrusion detecting alarm and outside automatic telephone function, along with the indoor home electronic appliance controlling process.

When a person intrudes without the normal authenticating process, intrusion detecting sensor (1110) such as movement detecting sensor installed indoors detects the intrusion and transmits sixth very high frequency (VHF6) including the detecting signal to main unit (1100). For example, if intrusion is detected when the door is closed, it can be assumed that there is no regular authenticating process.

Main unit (1100) receives sixth very high frequency (VHF6) transmitted by intrusion detecting unit (1110) and operates voice alarm device (1120) to alarm.

At the same time, main unit (1100) outputs emergency telephone number and alarming message to telephone controlling unit (1150). In order to provide the emergency telephone number, it is preferred to record the same number as the telephone number for home automation that is used for controlling the indoor home electronic appliance.

Telephone controlling unit (1150) receives emergency telephone number and alarming message from main unit (1100) and converts converting switch (1153) to home automation mode, thereby making it possible to control by outside telephone. Next, it calls with the telephone number by which home electronic appliance is controllable, that is, the emergency telephone number and then, sends alarming message.

The present invention provides a door locking unit wherein a door is automatically controllable by radio communication between a main unit and a wireless card without additional construction. If it is confirmed that a person approaching the door is authorized one, the locking device transmits unlocking signal and then, unlocks the door using the signal. The communicating technique using radio communication was described in Korean Patent Application No. 10-2000-62028, which is incorporated herein by reference. The present invention uses the communication technique to apply to a building, thereby opening/closing the building door with ease. Using a pair of transmitter and receiving unit for communicating the main unit with each device (wireless card, door locking unit, controller and intrusion detecting sensor) reduces effects from noise in the communication between the devices, since signals with the same frequency band, which include characteristic code of the devices are transmitted/received. Further, the constitution of the main unit is also simplified. A controlling unit that can be wirelessly communicated using the main unit of building door recognizing system, is installed in a receptacle and an electronic appliance is connected so that power is supplied through the controlling unit. When control signal for controlling the power of the designated controlling unit and controlling unit designating signal are inputted through telephone line from the outside, the main unit transmits the control signal and characteristic code through an antenna. Thus, the designated controlling unit receives the signals to turn on/off the power. As a result, home automation system can be constituted with lower price.

In order to improve the reliability of locking device, an intrusion detecting sensor is installed and is connected to the main unit. If an intrusion is detected, the detecting signal is inputted to the main unit to output alarm bell with informing the intrusion by calling with the stored telephone number stored in the memory of the main unit.

The building door recognizing system according to the present invention comprises a main unit installed inside of the door, which periodically transmits long wave including synchronous signal to detect the wireless card's approach and then transmit locking/unlocking signal of a door locking unit, transmits power controlling signal of controlling unit through telephone line, and detects intrusion by wireless intrusion detecting sensor to operate voice alarm device; a wireless card that receives the synchronous signal transmitted from the main unit and then compares and analyzes ID code to transmit unlocking signal; a door locking unit that has door locking detecting switch for locking/unlocking the door by receiving door locking/unlocking signal from the main unit; door open/close detecting switch; and wireless intrusion detecting sensor. The wireless home automation system using the recognizing system is constituted by a telephone controlling unit that is installed inside the main unit and wirelessly controls controlling unit by receiving controlling unit designating signal and power control signal through outside telephone line, and controlling unit that receives the control signals from the telephone controlling unit to turn on/off power of electronic appliances connected thereto.

As described in the above, the present invention relates to a building door recognizing system and wireless home automation system and the method thereof. The door locking unit is automatically unlocked if a person carrying the wireless card approaches the door. There is no necessity of key holder or other detecting sensors. Further, if the user closes the door, the locking device is automatically operated so that the door cannot be opened. As a result, intrusion and destruction of the device can be prevented in advance.

Further, many IDs is inputted in the memory of the main unit so that the system can be applied to large office, hotel and the like that many people enters and exits.

A home automation system can be constituted to control power of home electronic appliances through outside telephone line.

According to the present invention, the communication between each device is wireless performed, not by wire. Thus, the construction of the system is easy.

II. Vehicle Door Controlling System

1. System Constitution

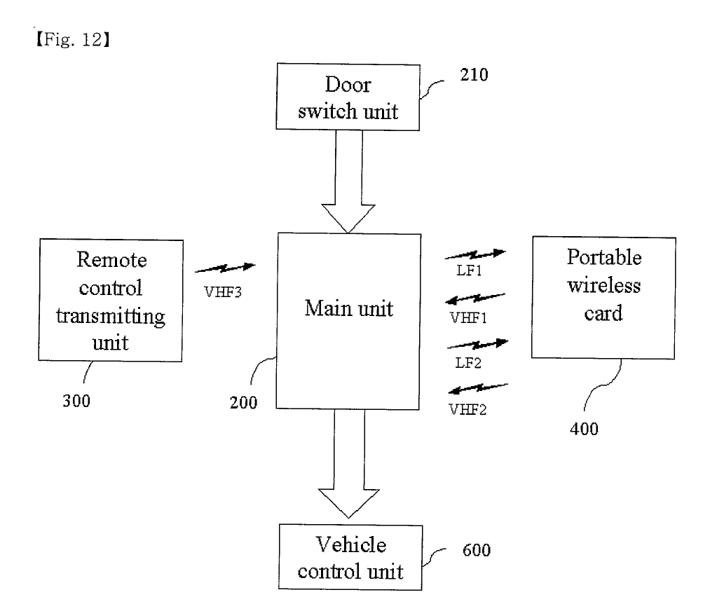

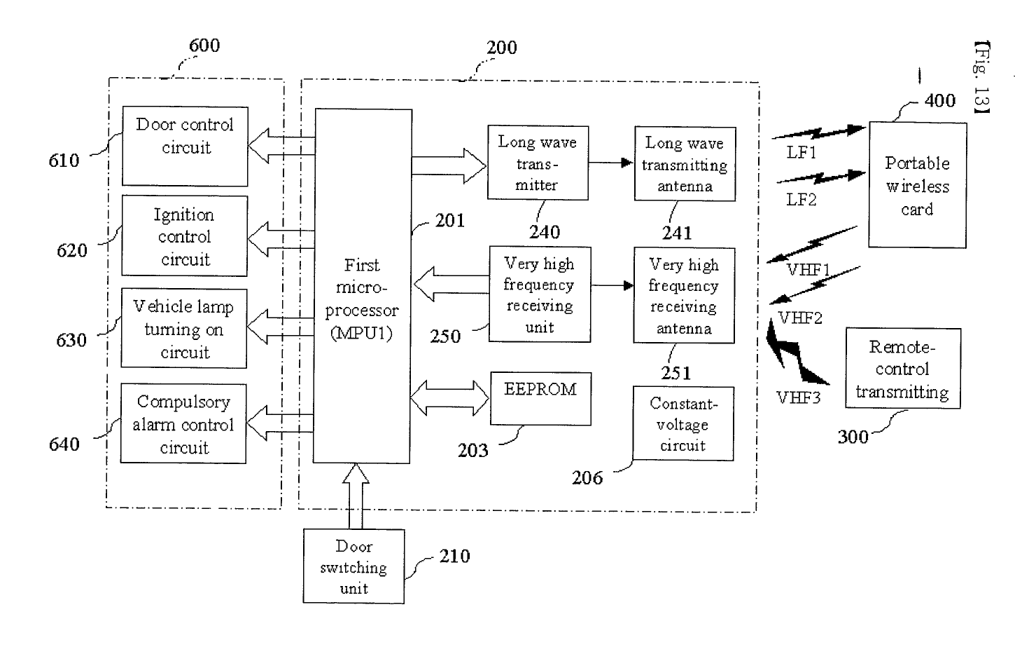

FIG. 12 shows a block diagram of vehicle door/ignition controlling system using the portable wireless card according to the present invention. The basic constitution is substantially same as the building door controlling system shown in FIG. 1.

The system comprises a main unit (200), remote-control transmitting unit (300), a portable wireless card (400), door switch unit (210) and vehicle controlling unit (600).

Main unit (200) is mounted inside the vehicle. The main unit periodically transmits first and second long wave (LF1, LF2) including synchronous signal and characteristic data, receives first and second very high frequency (VHF1, VHF2) transmitted from the portable wireless card, and thereby, reads characteristic data. If the read data is identical with the stored data, the main unit outputs a predetermined control signal. Vehicle controlling unit (600) is connected to the output side of main unit (200), switches on/off the ignition, and operates door locking unit and alarm device using the control signal outputted from main unit (200).

Remote-control transmitter (300) is mounted inside a vehicle. The transmitter transmits operating signal of third very high frequency (VHF3) to main unit (200) when a driver operates ignition button, mode button, and compulsory alarming button. Portable wireless card (400) receives first and second long wave (LF1, LF2) that include synchronous signal and characteristic data transmitted from main unit (200) and transmits first and second very high frequency (VHF1, VHF2) that include the first and second characteristic data and door unlocking signal. Door switch unit (210) is connected to the output terminal of main unit (200) and transmits door locking signal to main unit (200). Portable wireless card (400) and main unit (200) operate by processes of confirming the owner of the vehicle by bilateral data communication. Thus, a vehicle cannot be driven without the portable wireless card of the vehicle.

According to the other embodiment of the present invention, the remote-control transmitter and main unit (200) communicate by wire to each other. The remote-control transmitter can be supplied power from vehicle battery through main unit (200) without providing additional battery.

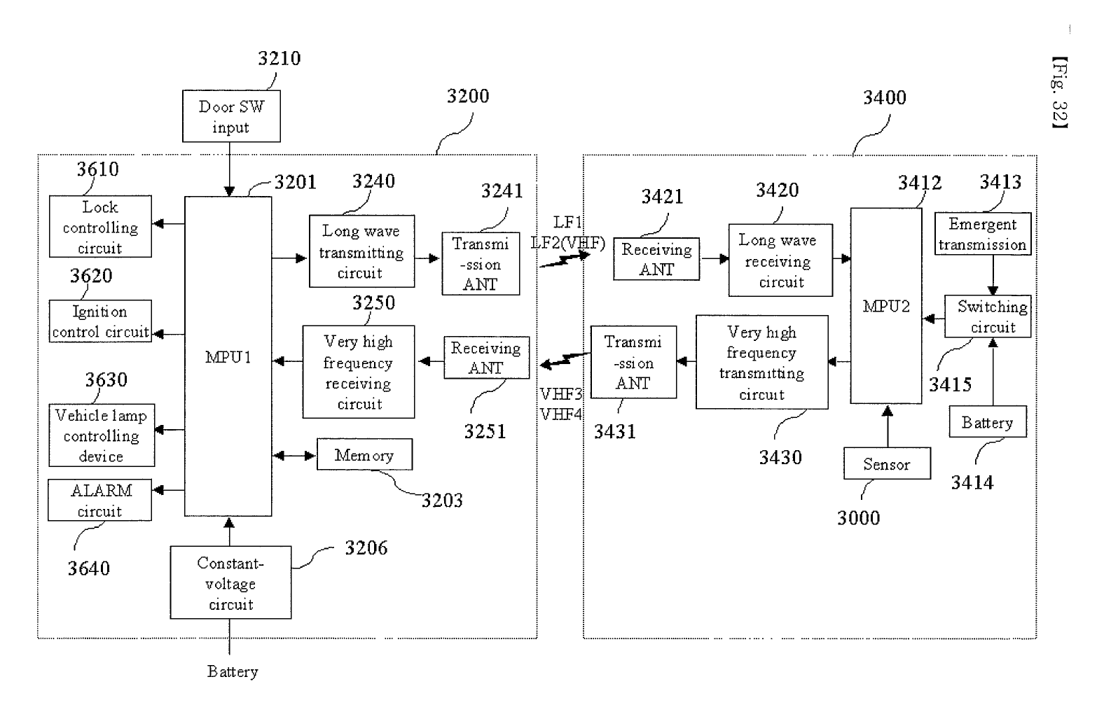

FIG. 32 shows a block diagram of main unit (3200) that is used with portable wireless card (3400) and of the card according to another embodiment of the present invention.

As shown in FIG. 32, portable wireless card (3400) has sensor (3000) for detecting movement of the card, which is housed within the card. When portable wireless card (3400) does not move, for example, when the card is just located in some place since the vehicle is not used for long time, the transmission of very high frequency from portable wireless card (3400) is prevented. Thus, transmitting very high frequency through very high transmitting circuit (3430) of portable wireless card (3400) is prevented. Therefore, it is possible to minimize the consumption of battery (3414) of portable wireless card (3400). When sensor (3000) detects the movement of card (3400), card (3400) normally operates to communicate with the main unit. The constitution of portable wireless card (3400) shown in FIG. 32 can be applied to another object device, for example, controlling device of building door that is described in section I, in addition to the vehicle door. The operation of the controlling device shown in FIG. 32 that will be described in the following can be applied to another object device if it is somewhat modified.

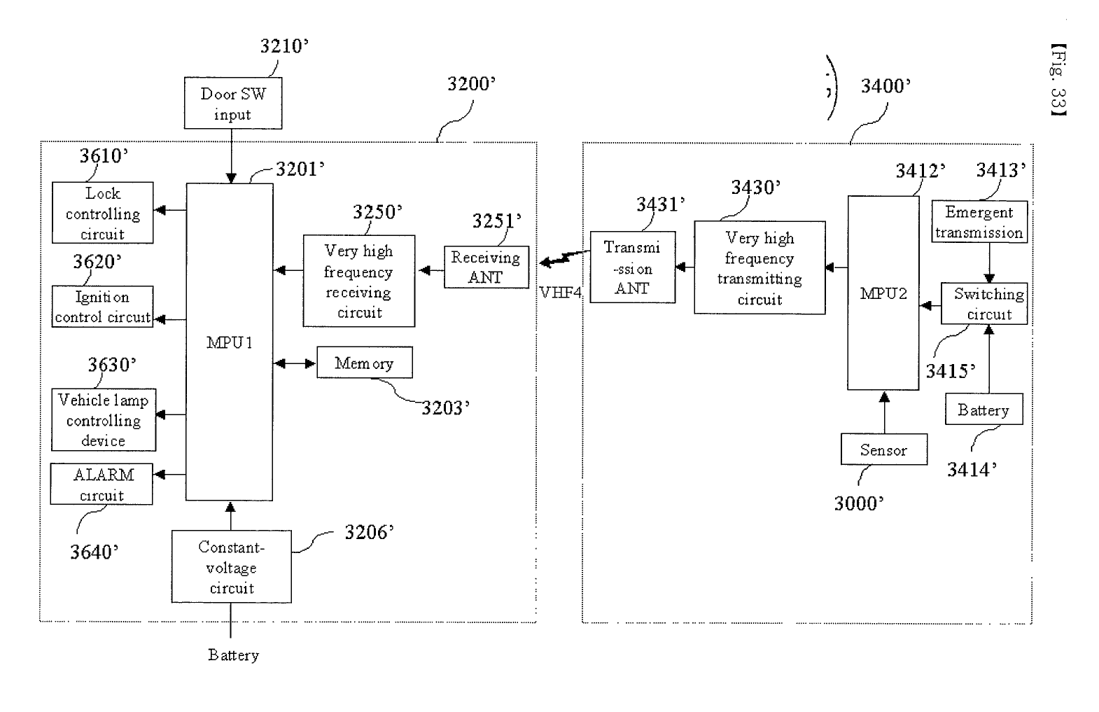

FIG. 33 shows a block diagram of portable wireless card (3400′) according to another embodiment of the present invention and main unit (3200′) that is used with the card. The constitution of portable wireless card (3400) shown in FIG. 33 can be another object device, for example, controlling device of building door that is described in section I, in addition to the vehicle door. The operation of the controlling device shown in FIG. 32 that will be described in the following can be applied to another object device if it is somewhat modified.

Portable wireless card (3400′) shown in FIG. 33 also comprises sensor (3000′) for detecting card movement. The card is different from the card shown in FIG. 32 in that, without many communications, sensor (3000′) detects the movement of card (3400′) to periodically transmit very high frequency through very high frequency transmitting circuit (3430′) and transmitting antenna (3431′), thereby unlocking just after confirming ID if the main unit exists within the detecting distance. According to the present embodiment, the circuit of the system is simplified.

In the following, the operation of vehicle door/ignition controlling device using the portable wireless card according to the present invention will be described.

Firstly, main unit (200) mounted on a vehicle periodically transmits first long wave (LF1) including synchronous signal. If a person carrying portable wireless card (400) approaches within a predetermined distance (for example, 1 m or less) from the vehicle, the card randomly generates period code to synchronized with the first long wave (LF1) and transmits first very high frequency (VHF1) carrying characteristic data stored in a channel among many channels.

New Allfree code is generated whenever the very high frequency is transmitted, referring to period code, mode code and checksum bit in addition to the characteristic data that are included in first very high frequency (VHF1) transmitted from portable wireless card (400). Further, it is prevented that the very high frequency is transmitted with the same period.

Main unit (200) receives first very high frequency (VHF1) transmitted by portable wireless card (400) and extracts the characteristic data. Next, the main unit compares the extracted characteristic data with the characteristic data stored in the memory (first ID certification). If they are identical, the main unit converts it to second long wave (LF2) including long wave ID and transmits the second long wave one again. The long wave ID carried in the second long wave (LF2) is compared. (second ID certification) If they are identical, the card transmits second very high frequency (VHF2) including ID signal and door unlocking signal.

Main unit (200) receives second very high frequency (VHF2) transmitted by portable wireless card (400) and thereafter, compares it with the characteristic data stored in the memory of main unit (200) (third ID certification). If they are identical, the vehicle door is unlocked.

In this embodiment, the characteristic data is repeatedly compared and certified three times by bilateral communication between main unit (200) and portable wireless card (400). Thus, reliability is improved and the interference caused by the same frequency is prevented.

If ignition button of remote-control transmitting unit (300) is operated when the door is unlocked by a person carrying portable wireless card (400), the ignition signal is transmitted to main unit (200) as third very high frequency. Main unit (200) receives third very high frequency (VHF3) transmitted from remote-control transmitting unit (300) and confirms ID with portable wireless card (400). If IDs are identical to each other, the main unit switches on the ignition of the vehicle. If IDs are not identical to each other, the main unit ignores the ignition signal. Thus, the vehicle cannot be started without the portable wireless card corresponding to the vehicle.

According to the operation of the mode button of remote-control transmitting unit (300), the system can be normally operated or can be operated with the conventional metal key. Thus, a person who is not an owner of the vehicle can drive the vehicle without portable wireless card (400) if necessary.

According to another embodiment of the present invention, it is possible to operate the remote-control transmitting unit without determining whether the wireless card exists or not, as described in the above, when the vehicle door is unlocked by the communication between portable wireless card (400) and main unit (400). According to the present embodiment, when a person carrying portable wireless card (400) approaches the vehicle, the door locking unit is unlocked following the ID certificating process described in the above by the communication between wireless card (400) and main unit (200). If the door locking unit is unlocked, alarming state is also released and the input of remote-control transmitting unit (300) is processed. Since, even if the vehicle locking device is unlocked and the vehicle is started, the alarm release state is maintained, the operation of remote-control transmitting unit (300) is possible. If a driver goes beyond the vehicle after the engine stops, the locking device starts to operate and the alarm device also operates. Therefore, after that, the input of remote-control transmitting unit (300) is ignored until confirmation of portable wireless card (400).

In this way, if, after the engine stops, the driver goes beyond the vehicle more than a predetermined distance (for example, 5 m), the ID communication between portable wireless card (400) and main unit (200) stops and the door is automatically locked and returns to the initial state. Thus, the vehicle door can be automatically opened/closed without the conventional metal key.

All of the processes of the present embodiment are performed by bilateral communication between portable wireless card (400) and main unit (200) for confirming the owner of the vehicle. Thus, driving the vehicle is impossible without portable wireless card (400) corresponding to the vehicle.

According to a preferred embodiment of the present invention, an important circuit is constituted by subminiature microchip that is easy to be installed inside a vehicle and hybrid chip. In particular, it is desirable that portable wireless card (400) to be kept in a wallet or pocket is very light, and has very small size and that the card is designed so as to have long durability.

The device of the present invention is economical since the device can be obtained with money for purchasing conventional vehicle alarm. In particular, if the key box of a vehicle can be removed and the device of the present invention is mounted, there is no necessary to use metal key. Thus, car theft can be reduced and the driving space can be enlarged.

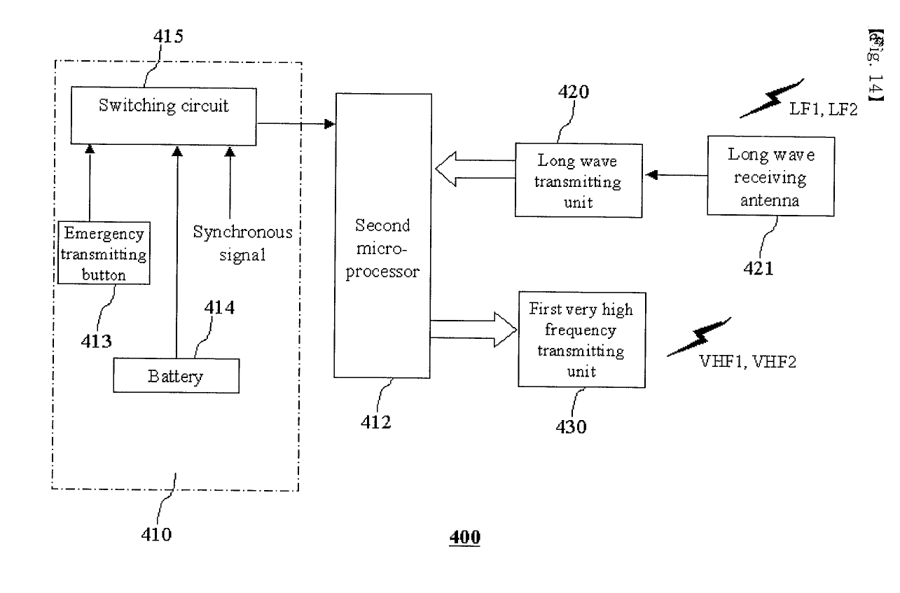

FIG. 13 shows a detailed block diagram of main unit (200) and vehicle controlling unit (600) in vehicle door/ignition controlling device using the portable wireless card according to the present invention.

Main unit (200) comprises a first microprocessor (201), a long wave transmitting unit (240), a long wave receiving antenna (241), a very high frequency receiving unit (250), a very high frequency receiving antenna (251), EEPROM (203) and constant-voltage circuit (206).

Long wave transmitting unit (240) generates first and second long waves (LF1, LF2) that includes synchronous signal and long wave ID to portable wireless card (400). Long wave transmitting antenna (241) transmits first and second long waves (LF1, LF2) outputted from long wave transmitting unit (240).

Very high frequency receiving antenna (251) receives first and second very high frequency (VHF1, VHF2) including first and second characteristic data transmitted from portable wireless card (400) and door unlocking signal, and third very high frequency (VHF3) transmitted when each button of remote-control transmitting unit (300) mounted inside the vehicle is operated. Very high frequency receiving unit (250) stabilizes and formalizes the very high frequency received through very high frequency receiving antenna (251) to output the stabilized and formalized one.

First microprocessor (201) is connected to the input terminal of long wave transmitting unit (240) and the output terminal of very high frequency receiving unit (250). The microprocessor compares the characteristic data transmitted from portable wireless card (400) and remote-control transmitting unit (300), analyzes and reads the data. And the microprocessor transmits the characteristic data through long wave transmitting unit (240) and outputs a predetermined control signal to vehicle controlling unit (600). EEPROM (203) having all of the control programs recorded therein is connected to first microprocessor (201). Further, door switch unit (210) sending door open/close signal to first microprocessor (201) is connected to the microprocessor.

Vehicle Controlling unit (600) is connected to the output terminal of first microprocessor (201). Vehicle controlling unit (600) comprises an ignition controlling circuit (620) for starting the vehicle by applying ignition coil when ignition button of remote-control transmitting unit (300) is operated, a vehicle tail lamp lighting circuit (630) for lighting the lamp and outputting alarming sound when a compulsory button is operated, compulsory alarm controlling circuit (640), and door controlling circuit (610) for locking and unlocking the door depending on the movement of portable wireless card (400).

FIG. 14 shows a detailed block diagram of portable wireless card (400) according to the present invention. As described in FIG. 14, portable wireless card (400) comprises long wave receiving unit (420), long wave receiving antenna (421), first very high frequency transmitting unit (430), second microprocessor (412) and drive (410).

Long wave receiving unit (420) receives first and second long waves (LF1, LF2) that include synchronous signal and long wave ID that are transmitted from main unit (200). First very high frequency transmitting unit (430) transmits, to main unit (200), first and second very high frequency (VHF1, VHF2) that include first and second characteristic data and door unlocking signal. Second microprocessor (412) compares synchronous signal and characteristic data received from long wave receiving unit (420), analyzes them and outputs a predetermined data through first very high frequency transmitting unit (430). Drive (410) is connected to second microprocessor (412) and includes switching circuit (415) supplying power of battery (414) to second microprocessor (412) by synchronous signal and emergency transmitting button (413).

FIG. 15 shows a detailed block diagram of remote-control transmitting unit (300) mounted inside a vehicle according to the present invention. As shown in FIG. 15, remote-control transmitting unit (300) comprises an ignition button (311), mode button (312), compulsory alarming button (313), automatic ignition converting switch (314), third microprocessor (315), second very high frequency transmitting unit (320) and battery (318).

Third microprocessor (315) outputs control signal in proportion to the operation of each button (311 to 314). Second very high frequency transmitting unit (320) transmits third very high frequency (VHF3) that is an operation signal, to main unit (200), according to the control signal of third microprocessor (315). Further, according to a preferred embodiment of the present invention, remote-control transmitting unit (300) further comprises a start lamp (316) and mode lamp (317) that show the operation condition according to the control of third microprocessor (315).

2. System Operation

In the following, the operation of vehicle door/ignition controlling system according to the present invention will be described.

(1) Vehicle Door and Unlocking Operation

Receiving command of first microprocessor (201) of main unit (200), long wave receiving unit (240) periodically generates first long wave (LF1) of 100 kHz, including synchronous signal. First long wave (LF1) is transmitted through long wave transmitting antenna (241). If long wave receiving unit (420) of portable wireless card (400) receives first long wave (LF1) transmitted from long wave transmitting antenna (241) of main unit (200) when portable wireless card (400) approaches within a predetermined distance for example, 1 m from the vehicle, long wave receiving unit (420) is synchronized by first long wave (LF1) and turns on circuit of portable wireless card (400) using energy of received signal.

Second microprocessor (412) in portable wireless card (400) controls first very high frequency transmitting unit (430) to randomly generate period code and transmits first very high frequency (VHF1) with characteristic data stored in a channel among many channels. The transmitted first very high frequency (VHF1) is received to very high frequency receiving unit (250) through very high frequency receiving antenna (251) of main unit (200). The received first very high frequency is stabilized and is formalized to be transmitted to first microprocessor (201).

Main unit (200) receives first very high frequency (VHF1) transmitted by portable wireless card (400) and extracts characteristic data included in the first very high frequency. Next, the extracted data is compared with the characteristic data stored in the memory (first ID certification). If they are identical, long wave transmitting unit (240) is controlled to transmit second long wave (LF2) through long wave transmitting antenna (241). Second long wave (LF2) is received by long wave receiving unit (420) in portable wireless card (400), and thereafter, is stabilized and formalized to be transmitted to second microprocessor and be compared with period code generated with random method (second ID certification). If they are identical, first very high frequency transmitting unit (430) is controlled to transmit second very high frequency (VHF2) including ID signal and door unlocking signal.

First microprocessor (201) of main unit (200) receives second very high frequency (VHF2) transmitted by portable wireless card (400) through very high frequency receiving antenna (251) and very high frequency receiving unit (250), and compares the received characteristic data and the characteristic data stored in EEPROM (203) (third ID certification). If they are identical, door controlling circuit (610) of vehicle controlling unit (600) is controlled to unlock the vehicle door.

If a driver goes beyond more than a predetermined distance (for example, 5 m) from the vehicle while first microprocessor (201) recognizes the driver by bilateral data communication between portable wireless card (400) and main unit (200), very high frequency transmitting antenna (251) of main unit (200) cannot receive characteristic data since second very high frequency (VHF2) transmitted from portable wireless card (400) disappears. Thus, first microprocessor (201) controls door controlling circuit (610) of vehicle controlling unit (600) to lock the door and return to the initial state.

Door switch unit (210) detects whether the vehicle door is opened or not when main unit (200) returns to the initial state or when main unit is being operated, and defines the operation of first microprocessor (201).

The operation of the embodiment using portable wireless card (3400) shown in FIG. 32 will be described in the following.

Since very high frequency transmitting circuit (3430) does not operate when portable wireless card (3400) does not move, the card does not transmit electronic wave. If sensor (3000) detects the movement of portable wireless card (3400), the card is turned on to transmit very high frequencies (VHF3, VHF4) through transmitting antenna (3431). Other communicating operation with main unit (3200) is same as described in the above.

The operation of the embodiment using portable wireless card (3400′) shown in FIG. 33 will be described in the following.

In this embodiment, if sensor (3000′) detects the movement of card (3400′), the card is turned on to transmit very high frequency (VHF4) including unlocking signal through transmitting antenna (3431′). Main unit (3200′) that receives it unlocks the vehicle door. In the embodiment, communicating processes are omitted.

(2) Operation of Vehicle Ignition Control

After the vehicle door is unlocked by normal operation of portable wireless card (400), if a driver operates ignition button (311) provided in remote-control transmitting unit (300) shown in FIG. 15, mounted inside the vehicle in order to drive, third microprocessor (315) controls second very high frequency transmitting unit (320) to transmit third very high frequency (VHF3) that is characteristic data including ignition signal, to main unit (200). Third very high frequency (VHF3) is received to very high receiving unit (250) through very high frequency receiving antenna (251) of main unit (200). The received third very high frequency is stabilized and formalized to be transmitted to first microprocessor (201).

If ignition signal is inputted from remote-control transmitting unit (300), first microprocessor (201) communicates with portable wireless card (400) continuously to certify ID. If the ID is identical with ID stored in main unit (200), ignition controlling circuit (620) of vehicle controlling unit (600) is driven to start the vehicle. If they are not identical with each other, the ignition signal is ignored. Thus, the vehicle cannot be started without portable wireless card (400) corresponding to the vehicle.

If the driver operates mode button (312) of remote-control transmitting unit (300) of FIG. 15, which is mounted inside the vehicle so as to stop all of the system operation, conventional metal key can be used. Thus, a person except the driver can drive the vehicle without portable wireless card (400) if necessary. If the mode is converted, the system normally operates. When ignition signal and mode signal are inputted, the system confirms the owner by characteristic data communication with portable wireless card (400) and then operate.

When ignition button (311) and mode button (312) are operated, start lamp (316) and mode lamp (317) are lighted and show the operation state according to the control of third microprocessor (315). Compulsory alarming button (313) can be operated to turn on alarming bell and automatic ignition converting switch (314) can be selected to determine the vehicle ignition mode, i.e., manual ignition or automatic ignition.

All operations described in the above can be possible only after the characteristic data is confirmed by bilateral data communication between portable wireless card (400) and main unit (200). Thus, even if a third party opens the vehicle door compulsorily and starts the vehicle with the conventional metal key, the vehicle cannot be started. Further, compulsory alarm controlling circuit (640) is operated to output alarming sound.

If the system is constituted so as to receive and transmit very high frequency (VHF) or ultra-high frequency (UHF) without long wave receiving unit (420) of portable wireless card (400) and long wave transmitting unit (240) of main unit (200), durability of battery (414) of portable wireless card (400) can be prolonged. Further, the transmitting speed increases and the detecting distance can be extended more than 100 m.

If portable wireless card (400) is provided with additional long wave (LF) induction receiving antenna and alarm function, the output state of electromagnetic wave generated from TV, computer monitor and the like can be recognized. That is, if portable wireless card (400) approaches within a distance detecting electromagnetic wave, the alarm is operated to inform that the user is exposed to dangerous electromagnetic wave, thereby preventing a human body from being exposed to dangerous electromagnetic wave.

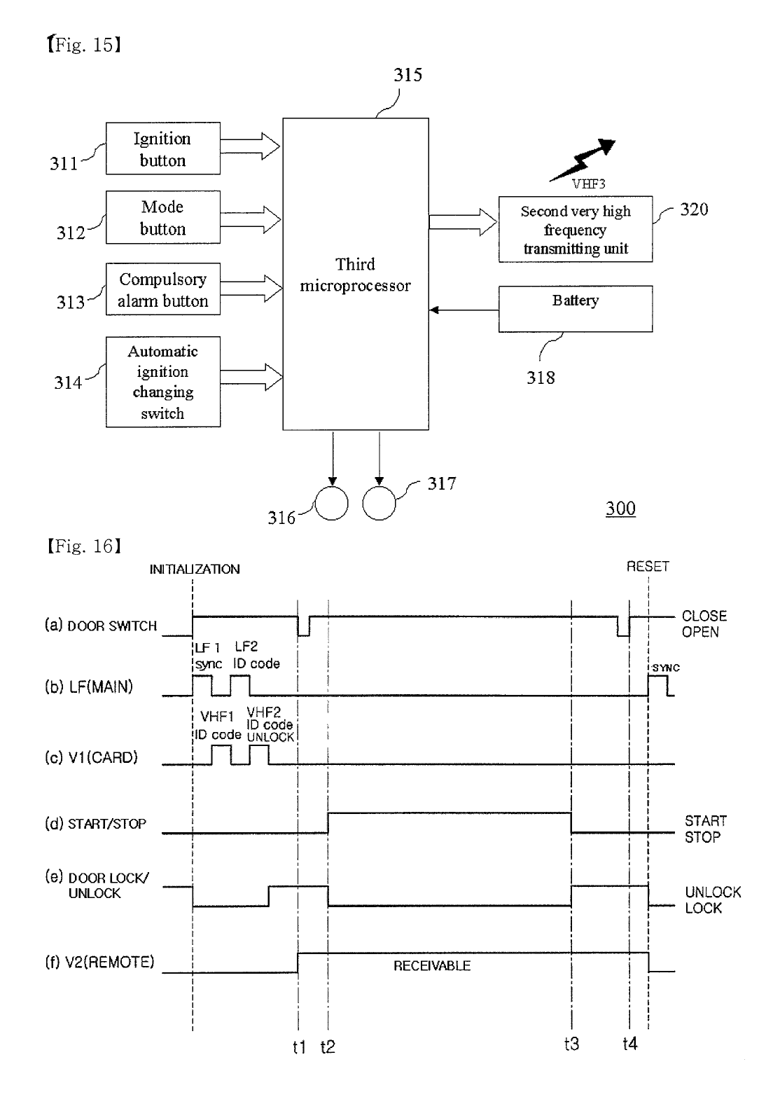

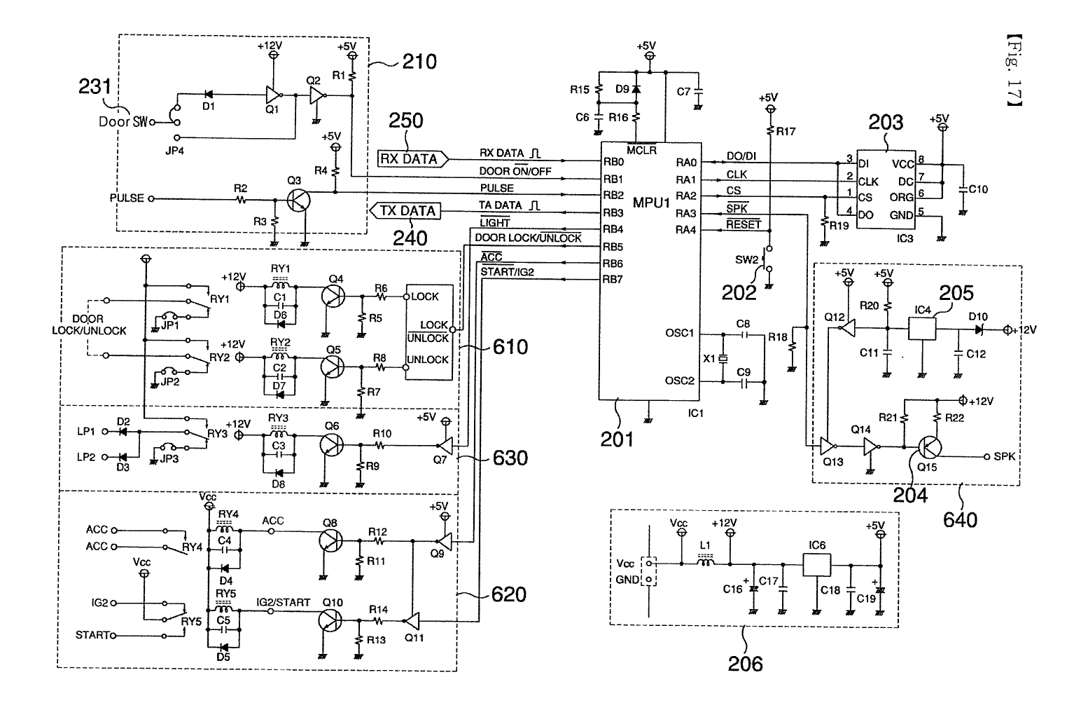

FIG. 16 shows system timing drawing of vehicle door/ignition controlling device using the portable wireless card according to the present invention. In the initial state, the vehicle door is closed as in FIG. 16a and main unit (200) periodically transmits first long wave (LF1) of synchronous signal as shown in FIG. 16b.

In the initial state, if portable wireless card (400) is within a predetermined distance from the vehicle, the first long wave (LF1) is received as in FIG. 16c and characteristic data is compared. If the characteristic data is identical, portable wireless card (400) transmits door unlocking signal of VHF2 as in FIG. 16c to unlock the vehicle door. In the event that the vehicle door is not opened within a predetermined time (for example, 4 seconds), the unlocking state is maintained if the card exists. The door is automatically locked after a predetermined time (for example, 80 seconds).

In the event that the door is opened within a predetermined time, for example 4 seconds, the unlocking state is maintained. When it is detected by door switch unit (210) that the door is closed and when ignition button (311) is operated (see t₂ in FIG. 16d) in the state where portable wireless card (400) exists, the door is automatically locked. Just after the door is opened (see t₁ in FIG. 16a), the system normally operates and receives the operation of ignition and mode button from remote-control transmitting unit (300) until the system is reset.

When each button of remote-control transmitting unit (300) is operated, main unit (200) transmits first long wave (LF1) including synchronous signal to confirm the characteristic data of portable wireless card (400). The system is normally operated only if the characteristic data is identical to each other. When the engine of the vehicle is stopped, the door is automatically opened after portable wireless card (400) is confirmed. When the driver gets off the vehicle and closes the door (t₄ in FIG. 16a), the characteristic data of portable wireless card (400) is detected at a predetermined time (for example, 4 seconds) intervals. If the characteristic data is not identical, the door is locked and all circuits are reset so that main unit (200) periodically transmits synchronous signal once again.

(3) Explanation for Controlling System Circuit

The present invention will be described in more detail with reference to the detailed circuits shown in FIGS. 17 to 20.

(A) Circuit of Main Unit and Vehicle Controlling Unit

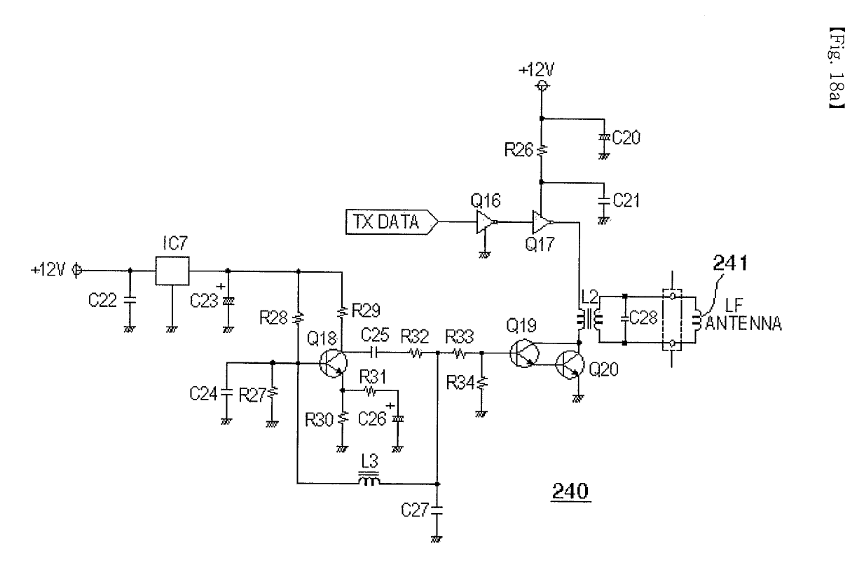

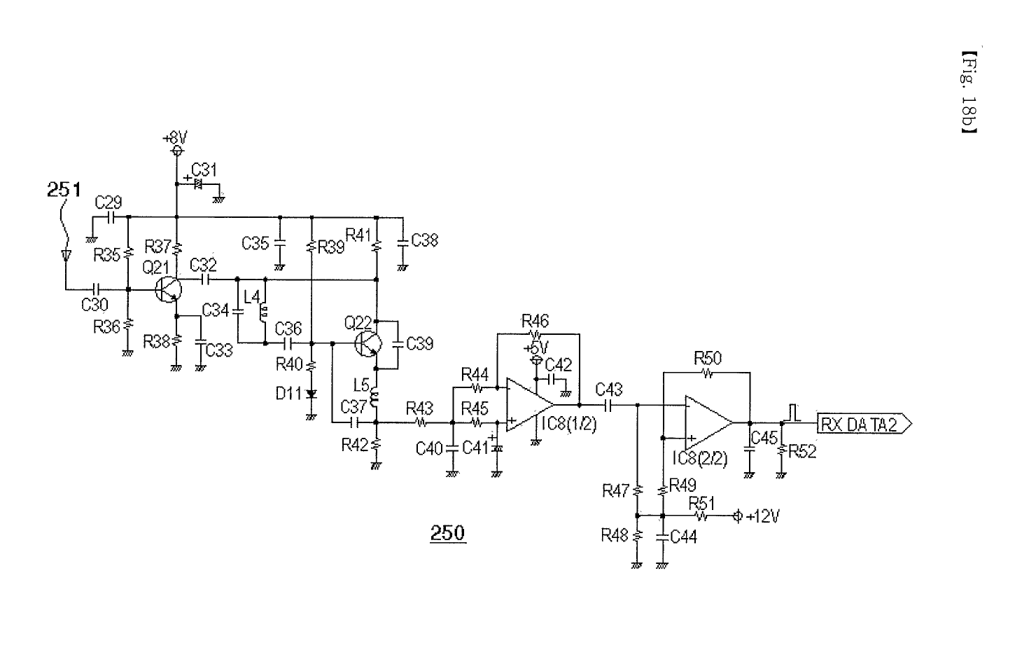

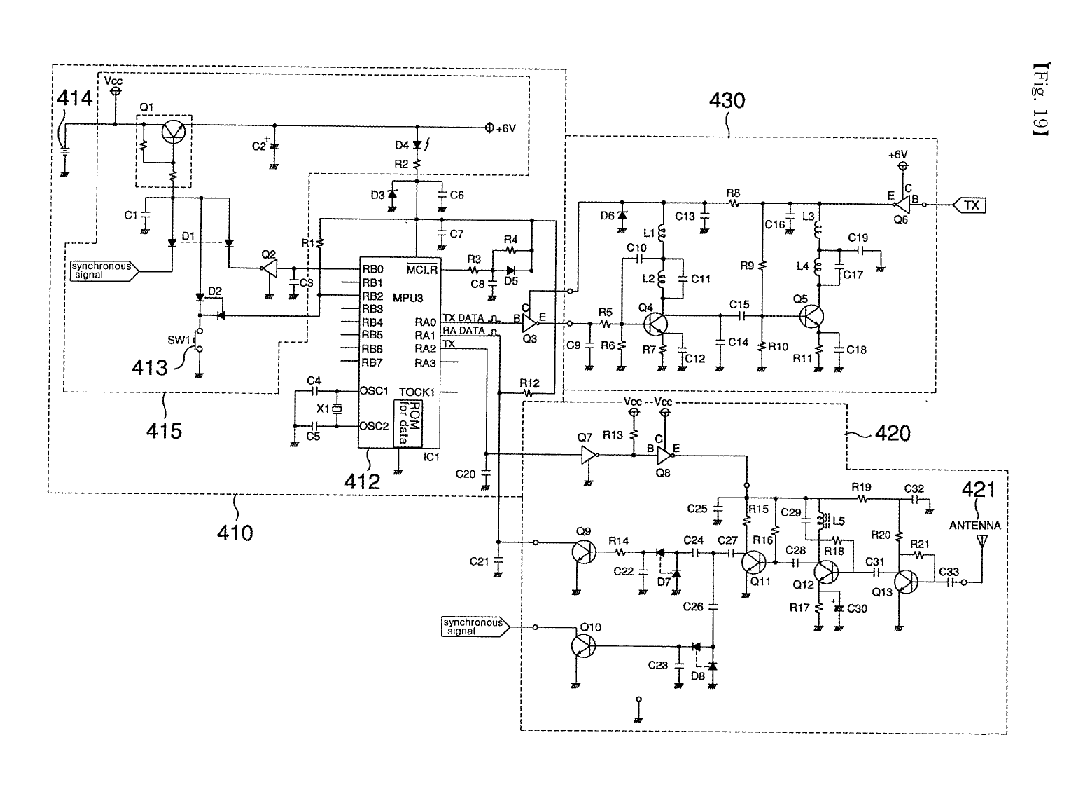

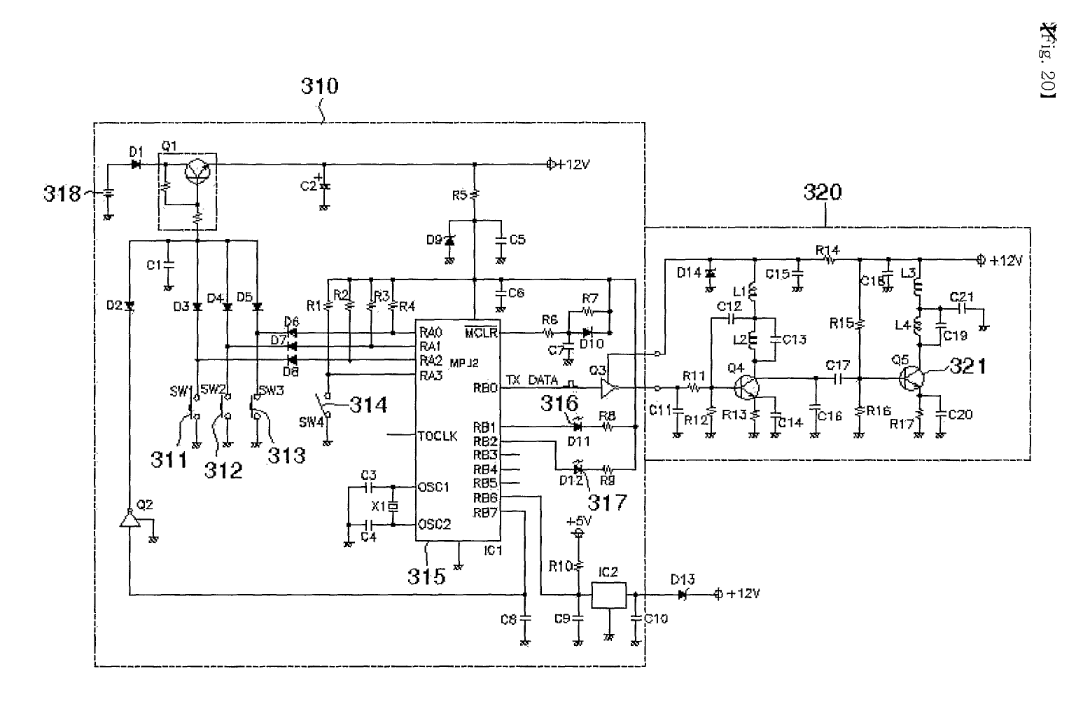

FIG. 17 shows detailed circuits of main unit and vehicle controlling unit according to the present invention. FIG. 18a shows a detailed circuit diagram of long wave transmitting unit of the main unit according to the present invention and FIG. 18b shows a detailed circuit diagram of the main unit according to the present invention. FIGS. 19 and 20 show a detailed circuit diagram of portable wireless card according to the present invention and remote-control transmitting unit according to the present invention, respectively.

The operation of main unit (200) and vehicle controlling unit (600) shown in FIGS. 17, 18 and 18b will be described in the following.

Constant-voltage circuit (206) receives power of +12 V from the vehicle to supply the power to main unit (200). +12 V (Vcc) for the vehicle, +12 V from which alternate current component is removed, and +5 V that passed constant-voltage device (IC6) are outputted and is supplied to main unit (200).

According to a preferred embodiment of the present invention, oscillating circuit of the first microprocessor (201) uses quartz oscillator (X1) and condenser (C8, C9). The circuit uses EEPROM (203) to store data and receives driving power through constant-voltage circuit (206) from vehicle.

The first microprocessor (201) operated by the power transmits synchronous signal to long wave transmitting unit (240) shown in FIG. 18a through RB3 port. The signal is switched to high speed switching transistor of Q16 and Q17 and passes LC oscillating circuit (Colpitts oscillating) consisting of Q18, L3, C25 that are voltage-divided biased. Thereafter, it is amplified by Darlington connection consisting of transistor (Q19, Q20), and is transmitted by long wave transmitting antenna (241) of coil antenna after being converted to first and second long waves (LF1, LF2) by long wave outputting transformer (L2).

The first and second long waves (LF1, LF2) transmitted by main unit (200) communicate with portable wireless card (400) shown in FIGS. 14 and 19. As a result of the communication, portable wireless card (400) transmits the first and second very high frequency (VHF1, VHF2) to main unit (200), which are received by very high receiving unit (250) of main unit (200).

The first and second very high frequency (VHF1, VHF2) transmitted by portable wireless card (400) and third very high frequency (VHF3) transmitted by remote-control transmitting unit (300) are received by very high frequency receiving antenna (251) as shown in FIG. 18b, and pass coupling condenser (C30). Further, they are amplified and is synchronized by condenser (C37) and coil (L4). Thereafter, they are detected by transistor (Q22), coil (L5) and condenser (C37). Further, they are amplified and formalized by operational amplifier (IC8, IC8) and are inputted to RBO ports of the first microprocessor (1201) thereafter.

According to a preferred embodiment of the present invention, long wave receiving unit (240) and very high frequency receiving unit (250) are made to hybrid chip, and thus, consuming current at ordinary times and mis-operation are reduced and the circuit can be stabilized.

(B) Circuit Diagram of Vehicle Controlling Unit

The operation of circuits of vehicle controlling unit (600) shown in FIG. 17 will be described in the following.

If a door is abnormally opened without confirming characteristic data with portable wireless card (400) or if a signal of compulsory alarming button (313) of remote-control transmitting unit (300) is inputted through very high frequency receiving unit (250), “low” signal is outputted through RA3 port of the first microprocessor (201) and is high-speed switched to transistor (Q13, Q14) of compulsory alarm controlling circuit (640) to be amplified by fixed-biased transistor (Q15) and, thereafter alarming sound is outputted.

If the detected battery power is below a predetermined level, the alarming sound is outputted by power watching circuit (205). In order to compulsorily stop the alarming sound, the reset button (202) connected to the first microprocessor (201) should be pushed.

If compulsory alarming button (313) of remote-control transmitting unit (300) is operated simultaneously, “low” and “high” signals are repeatedly outputted to RB4 port of the first microprocessor (201). The signals are inverted by inverter (Q7) of vehicle tail lamp lighting circuit (630) to turn on/off transistor (Q6). According to the result, power of +12 V is periodically supplied to relay (RY3) and thereby, vehicle tail lamp (LP1, LP2) blinks by diode (D2, D3). Lamp's blinking informs driver or a person of some operation. Condenser (C3) and diode (D8) are circuits for stabilizing relay (RY3).

Door switch unit (210) confirms whether the door is opened or closed. If the door is opened, “low” signal is inputted to RBI port of the first microprocessor (201). If the door is closed, jump switch (JP4) of the door switch unit is jumped so that “high” signal is inputted.

Door controlling circuit (610) is controlled by door locking/unlocking signal outputted through RB5 port of the first microprocessor (201). The circuit connects locking signal and unlocking signal so that they are inverted using multi-vibrator (611) and is designed so that the operations of two relay (RY1, RY2) are opposite to each other. Thus, if the output of RB5 is “low,” the transistor (Q5) is turned on to apply power of +12 V to relay (RY2) so that the door is unlocked. If the output is “high,” the transistor (Q4) is turned on to apply power of +12 V to relay (RY2) so that the door is locked.

Ignition controlling circuit (620) is controlled by ACC and start signal outputted through RB6 and RB7 ports of the first microprocessor (201). When a vehicle is started, ACC signal is outputted as “low” through RB6 port by the inputted program. The signal is inverted to “high” by Q9, and thus, the transistor (Q8) is turned on to apply power of +12 V to relay (RY4) so that ACC output is maintained as “on” state.

The start signal that is outputted as “low” through RB7 port of the first microprocessor simultaneously, is inverted to “high” by Q11, and thereby, turns on the transistor (Q10) to apply power of +12 V to relay (RY5) so that Vcc is supplied as start signal for two seconds to start the vehicle. Thereafter, the output of RB7 port is inverted to “high” to supply Vcc to ignition coil (IG2).

(C) Circuit Diagram of Portable Wireless Card.

FIG. 19 shows a circuit diagram of the portable wireless card according to the present invention. As described in FIG. 19, the portable wireless card comprises processing unit (412) including second microprocessor (412), emergency transmitting button (413), battery (414), long wave receiving unit (420) and first very high frequency transmitting unit (430).

While power of Vcc of long wave receiving unit (420) passes Q8 to be supplied to long wave receiving unit (420) so that long wave receiving stand-by mode is maintained, if synchronous signal is received through receiving antenna (421) from main unit (200), the received signal passes coupling condenser (C28) and is pre-amplified by transistor (Q13). Thereafter, it is synchronized by transistor (Q12), coil (L5), and condenser (C29). Next, it passes coupling condenser (C28), is secondly amplified by transistor (Q11) and is detected by diode (D8), subsequently. Thereafter, it is amplified by the transistor (Q10) and is supplied to the second microprocessor (412) as synchronous signal. The transistor (Q1) is turned on by the synchronous signal so that battery (414) lights light emitting diode (D4) and supplies driving power to the second microprocessor (412), thereby operating portable wireless card (400).

Second microprocessor (412) of portable wireless card (400) is maintained to stand-by at ordinary times. Only when the first long wave signal (LF1) is received from main unit (200), second microprocessor (412) can be normally operated, thereby minimizing consuming current of portable wireless card (400). Thus, the exchange period for battery (414) can be maximized. Further, according to the above-described constitution, power of battery (414) can be supplied continuously through Q2 since “high” signal is outputted through RB0 by the inputted program until the work is terminated after second microprocessor (412) is operated using a synchronous signal.

The output of the transistor (Q11) of long wave receiving unit (420) is detected by diode (D7) and is amplified by the transistor (Q9) to be inputted to RA1 port of second microprocessor (412). Thereafter, it is compared with the data stored in data ROM (412) within second microprocessor (412).

If the compared data are identical, transmitting signal (TX) is converted to “low” through RA2 port so that Q6 of first very high frequency transmitting unit (430) is turned on to supply power to first very high frequency transmitting unit (430) along with transmitting characteristic data through RA0 of second microprocessor (412) after turning off driving power of long wave receiving unit (420). Thus, power to be consumed is minimized since long wave receiving unit (420) and first very high frequency transmitting unit (430) are operated alternatively.

The characteristic data of second microprocessor (412) applied to first very high frequency transmitting unit (430) passes oscillating circuit (Colpitts oscillating) consisting of the transistor (Q4) of first very high frequency transmitting unit (430), coil (L2) and condenser (C12) to oscillate first and second very high frequencies (VHF1, VHF2). Further, it passes coupling condenser (C17), is amplified by the transistor (Q5), and is transmitted through coil antenna (L4). The transmitted signal is received by very high frequency receiving antenna (251) of main unit (200).

According to a preferred embodiment of the present invention, long wave receiving unit (420) and first very high frequency transmitting unit (430) are constituted by hybrid chip, thereby drastically reducing consumed current at ordinary times. Thus, portable wireless card (400) can be designed so that the size of the card is minimized.

(D) Circuit Diagram of Remote-Control Transmitting Unit

FIG. 20 shows a circuit diagram of remote-control transmitting unit according to the present invention. The remote-control transmitting unit comprises ignition button (311), mode button (312), compulsory alarming button (313), automatic ignition converting switch (314), third microprocessor (315), battery (318) and second very high frequency transmitting unit (320).

When ignition button (311) is operated, the transistor (Q1) is turned on through diode (D3) to supply power of battery (318) to third microprocessor (315) so that “low” signal is inputted to RA2 port and thereby, ignition signal is recognized. Next, light emitting diode (316) is lighted through RB1 port along with outputting transmitting data to second very high frequency transmitting unit (320) through RB0 port.

When mode button (312) is operated, “low” signal is applied through RA1 port of third microprocessor (315) and diode (D4), and thus, light emitting diode (317) is lighted through RB2 along with outputting transmitting data to second very high frequency transmitting unit (320) through RB0 port.

When compulsory alarming button (313) is operated, third microprocessor (315) is operated through diode (D5) to output transmitting data to second very high frequency transmitting unit (320) through RB0 port. According to operation of automatic ignition converting switch (314), the system can be started automatically or manually. The switch can be operated by pressing mode button for more than 2 seconds.

Therefore, if transmitting data is inputted to second very high frequency transmitting unit (320) when ignition button (311), mode button (312) and compulsory alarming button (313) are operated, third very high frequency (VHF3) is oscillated through oscillating circuit (Colpitts oscillation) consisting of transistor (Q4), coil (L2) and condenser (C12), passes coupling condenser (C17) to be amplified by transistor (Q5), and is transmitted through coil antenna (L4), subsequently. The signal is received by very high frequency receiving antenna (251) of main unit (200). According to a preferred embodiment of the present invention, second very high frequency transmitting unit (320) is constituted by hybrid chip, thereby drastically reducing consuming current at ordinary times. Further, the unit can be designed so that the circuit is stabilized.

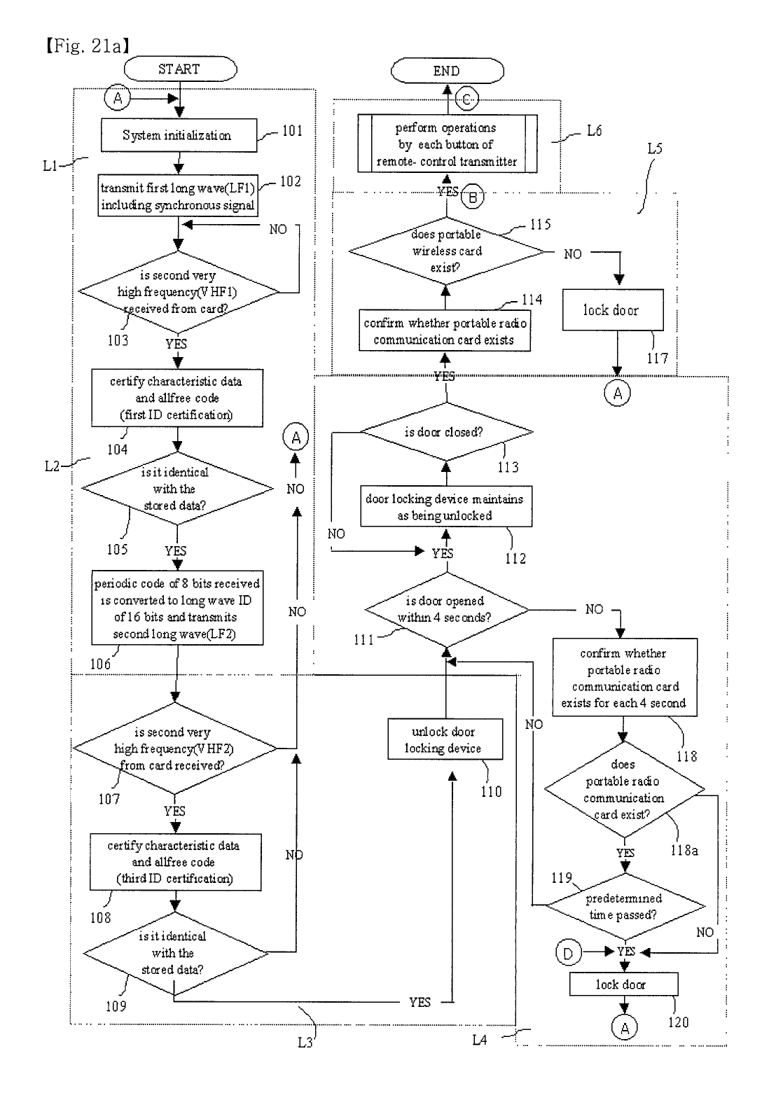

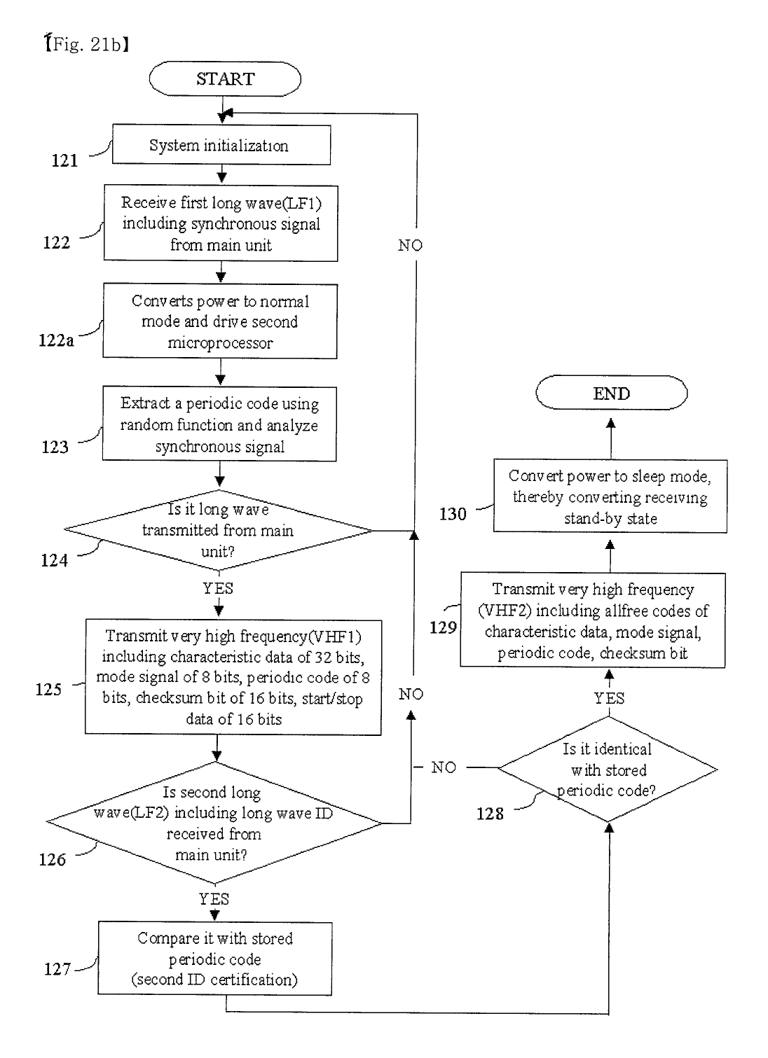

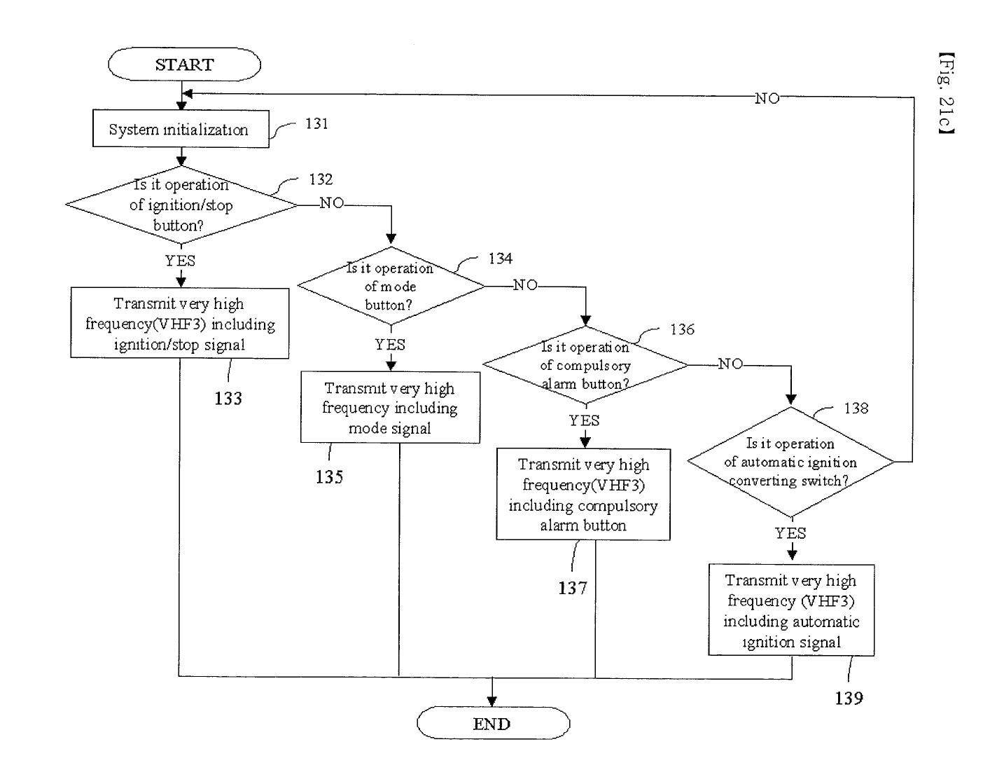

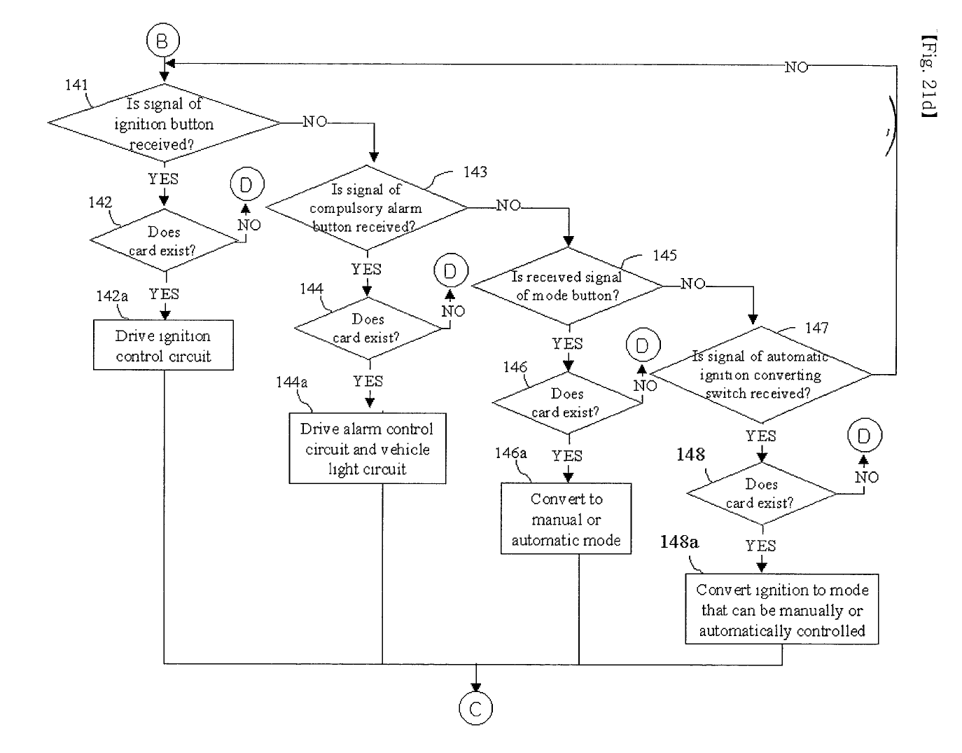

With reference to FIGS. 21a to 21c, the operation of main unit (200), portable wireless card (400) and first to third microprocessors (201, 315, 412) of remote-control transmitting unit (300) will be described in the following.

FIG. 21a shows a flow chart of operation of the main unit according to the present invention. FIG. 21b shows a flowchart of operation of the portable wireless card according to the present invention. FIG. 21c shows a flowchart of operation of the remote-control transmitting unit according to the present invention. FIG. 21d shows a sub-routine of FIG. 21a.

In the operation, main unit (200) and portable wireless card (400) repeatedly communicate with each other at two times. The first communication is for turning on portable wireless card (400) and generating allfree code in the card to transmit the code. The second communication is for comparing the allfree code received in main unit (200) with the characteristic data, recognizing the owner and unlocking the door.

(4) Description of Flowchart of Control Method

In the following, the flowchart of vehicle door/ignition control method will be described.

In FIG. 21a, when power is supplied to main unit (200), the system is initialized (Step 101). Next, main unit (200) transmits first long wave (LF1) including synchronous signal (Step 102). Further, it is continuously checked whether first very high frequency (VHF1) is received from portable wireless card (400) (Step 103). When the first very high frequency (VHF1) is received, characteristic data and allfree code is verified (Step 104), and thereafter, if it is determined that the verified data is identical with the stored data (Step 105), the received period code is converted to long wave ID of 16 bits to be loaded in second long wave (LF2) with start/stop bit of 4 bits and thereafter is transmitted (Step 106). If the received ID is not identical with the stored ID, first verifying process (L2) that returns to initial state of transmitting synchronous signal one again after a predetermined lag, is performed.

If it is determined that second very high frequency (VHF2) is received from portable wireless card (400) within a predetermined time after the first verifying process (L2) is performed (Step 107), the characteristic data and the allfree code is verified (Step 108). If it is determined that the verified data is identical with the stored data (Step 109), the door locking unit is released. If they are not identical with each other, second verifying process (L3) of returning to the initial state is performed.

After the second verifying process (L3) is completed, it is determined whether an owner of the vehicle opens the door within a predetermined time (for example, 4 seconds) (Step 111). If the door is not opened within the predetermined time (for example, 4 seconds), it is checked whether portable wireless card (400) exists or not at a predetermined time-interval (for example, 4 seconds) (Step 118). If it is determined that portable wireless card (400) is not detected (Step 118a) or if it is determined that a predetermined time (for example, 80 seconds) passes (Step 119), locking device controlling process (L4) of locking the door is performed.

In the locking device controlling process (L4), it is determined whether the door is closed by the driver after the door is unlocked (Step 113). If the door is closed, it is checked whether portable wireless card (400) exists or not (Step 114). If it is determined that portable wireless card (400) is not detected, the door is locked (Step 117). If it is determined that portable wireless card (400) exists, driving preparing process (L5) of performing vehicle controlling process (L6) of controlling the vehicle by operation of button installed in remote-control transmitting unit (300), is performed, thereby completing the operation of main unit (200).

FIG. 21b shows a flowchart of operation of the portable wireless card according to the present invention. When power is supplied to portable wireless card (400), the system is initialized (Step 121) and receives first long wave (LF1) including synchronous signal transmitted from main unit (200) (Step 121). Driving power is supplied to second microprocessor (315) by the synchronous signal (Step 122a) and thus, the system is converted to a normal operation state. An arbitrary period code (for example, 0˜255) is extracted using a random function and received synchronous signal is analyzed simultaneously (Step 123) so that it is determined whether it is long wave transmitted by main unit (200) (Step 124). If it is determined that it is not the signal transmitted by main unit (200), the system is initialized.

If it is determined that the first long wave (LF1) is one transmitted by main unit (200), transmitted is first very high frequency (VHF1) including ID of 32 bits, mode of 8 bits, period code of 8 bits and checksum bits of 16 bits, start/stop 16 bits as proper period using the extracted period code among many channels (Step 125). Since the first very high frequency (VHF1) includes other signals (Allfree codes of 4 billions) in addition to the characteristic data, the security is improved

It is determined whether second long wave (LF2) including long wave ID is received from main unit (200) within a predetermined time after transmitting the first very high frequency (VHF1) is completed in the above step. (Step 126) If the second long wave (LF2) is received within the predetermined time, it is compared with the stored characteristic data and is analyzed (Step 127). If it is identical with the stored period code, the second very high frequency (VHF2) carrying Allfree code of 80 bits such as mode signal, period signal, ID signal and checksum bit is transmitted to main unit (200). Thereafter, the power of portable wireless card (400) is converted to sleep mode to be converted to long wave receiving stand-by (Step 130). This is for prolong the durability of battery by saving power of portable wireless card (400).

FIG. 21c shows a flowchart of operation of remote-control transmitting unit (300) according to the present invention. When power is supplied to the system, the system is initialized. (Step 131) Third very high frequency (VHF3) is transmitted depending on the driver's operation to the buttons.

If the driver operates ignition button (311) (Step 132), the vehicle is started and third very high frequency (VHF3) including stopping the engine is transmitted (Step 133). If the driver operates mode button (Step 134), third very high frequency (VHF3) including signal of automatic mode or manual mode is transmitted (Step 135).

Further, if compulsory alarming button (313) is operated, third very high frequency (VHF3) including compulsory alarming signal is transmitted (Step 137). If automatic ignition converting switch (314) is operated, third very high frequency (VHF3) including automatic ignition signal is transmitted to main unit (200) (Step 139).

FIG. 21d shows a flowchart of operation of sub-routine of FIG. 21a and shows controlling process of main unit (200) when each button of remote-control transmitting unit (300) is operated.

If it is determined that operation signal of ignition button (311) is received from remote-control transmitting unit (300) (Step 141), it is checked whether portable wireless cared (400) exists (Step 142a). If the card exists, ignition controlling circuit (620) is controlled to start the vehicle. If it is determined that operation signal of compulsory alarming button (313) is received (Step 143), it is checked whether portable wireless card (400) exists (Step 144). If the card exists, vehicle tail lamp lighting circuit (630) and compulsory alarming circuit (640) are controlled to output alarming sound and to blink the vehicle tail lamp (Step 144a).

If it is determined that the operation signal of mode button (312) is received from remote-control transmitting unit (300), it is checked whether portable wireless card (400) exists (Step 146). If the card exists, the system is converted to automatic or manual mode (Step 146a). If it is determined that operation signal of automatic ignition converting switch (314) is received (Step 147), it is checked whether portable wireless card (400) exists (Step 148). If the card exists, the system is converted to automatic ignition mode or manual ignition mode. (Step 148a)

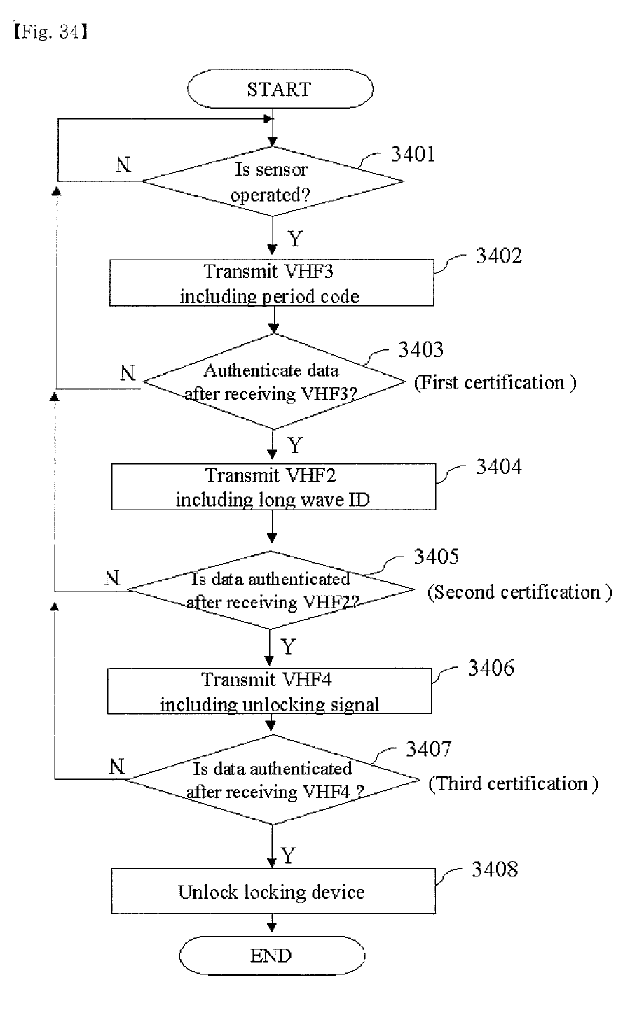

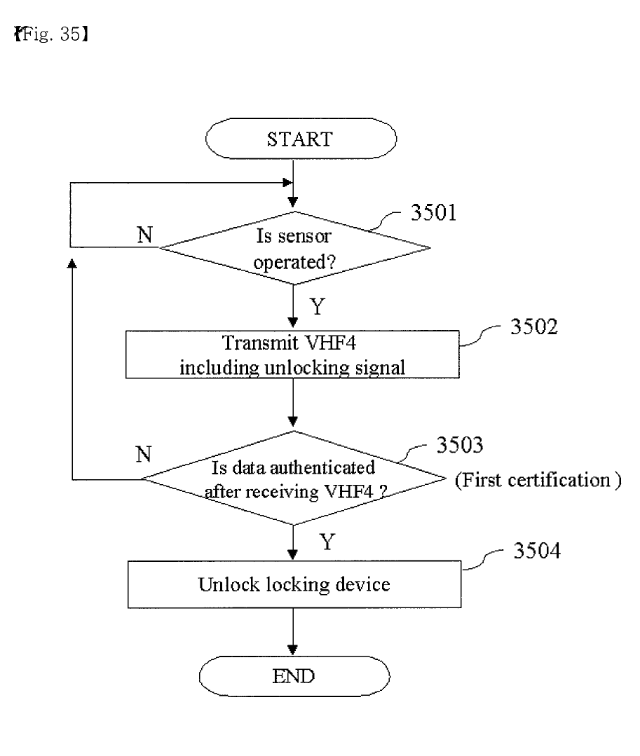

FIG. 34 shows a flowchart of unlocking vehicle door in the embodiment using portable wireless card (3400) shown in FIG. 32.

Firstly, it is determined whether sensor (3000) of portable wireless card (3400) operates or not. (Step 3401) If the sensor detects the movement of card (3400), very high frequency signal (VHF3) including period code is transmitted (Step 3402). Main unit (3200) receiving the very high frequency signal verifies the data (Step 3403). If the data is identical with the data stored in the memory, very high frequency (VHF2) including long wave ID is transmitted (Step 3404). Portable wireless card (3400) receiving the very high frequency (VHF2) verifies the data (Step 3405). If it is determined that they are identical with each other, very high frequency (VHF4) including unlocking signal is transmitted (Step 3406). Main unit (3200) receiving the very high frequency (VHF4) including unlocking signal verifies the data one again (Step 3407). If it is determined that they are identical, the locking device is unlocked. (Step 3408)

FIG. 35 shows a flowchart of unlocking vehicle door in the embodiment using portable wireless card (3400′) shown in FIG. 33.

In this embodiment, firstly, it is determined whether sensor (3000′) operates or not (Step 3501). If it is determined that portable wireless card (3400′) moves, very high frequency (VHF4) including unlocking signal is immediately transmitted with period (Step 3502). When a person having portable wireless card (3400′) approaches the vehicle (for example, within 1 m from the vehicle), main unit (3200′) receives the very high frequency (VHF4) and determines whether the data is identical with the characteristic data stored in the memory (3203′) (Step 3503). If it is determined that they are identical with each other, the locking device is unlocked (Step 3504).

The present embodiment removes interference caused from the same frequency, by repeatedly transmitting very high frequency with a period using the main unit, portable wireless card and remote-control transmitting unit. That is, if a person having the portable wireless card in a wallet and the like approaches a vehicle, the vehicle recognizes the person and the vehicle door is automatically opened/closed. Further, starting/stopping can be also performed by ignition button of the remote-control transmitting unit. The system can be mounted when the vehicle is manufactured and if key box is removed, the vehicle can be operated without a conventional metal key. Further, the vehicle cannot be started without the portable wireless card and thus, the car-theft can be prevented in advance.

In the above, some numerical values are used for describing the preferred embodiment of the present invention. However, it should be understood that the scope of the present invention is not limited by the numerical values and that the scope is interpreted by the attached claims.

In the above, the present invention is described to be used for controlling building and vehicle door and indoor home electronic appliances. However, the scope of the present invention is not limited to these uses. The present invention can be applied to all of the object system that can be provided with main unit and can be controlled by a portable wireless card. The present invention can be applied to a system that requires control through user authentication, such as power on/off, door open/close, entrance and exit control of industrial apparatus, industrial building, a motorcycle, airplane and ship.

What is claimed is:

1. A wireless identification device for use with an identification checking system, the device comprising:
means for receiving a first wireless signal from a source;
means for wireless-transmitting a first responsive signal incorporating a random security code;
means for receiving a second wireless signal from the source;
means for checking whether the second wireless signal incorporates a derivative code of the random security code; and
means for wirelessly transmitting a second responsive signal confirming the incorporation of the derivative code into the second wireless signal.

2. The device of claim 1, wherein the first responsive signal further incorporates an identification code of the device.

3. The device of claim 1, wherein the first and second wireless signals have a carrier frequency in the range of low frequency (LF).

4. The device of claim 1, wherein the first and second responsive signals have a carrier frequency in the range of very high frequency (VHF).

5. A wireless security access system, comprising
a portable unit;
a control unit;
wherein the portable unit comprises:
means for receiving a first wireless signal,
means for wireless-transmitting a first responsive signal incorporating a random security code,
means for receiving a second wireless signal,
means for checking whether the second wireless signal incorporates derivative code of the random security code, and
means for wirelessly transmitting a second responsive signal confirming the incorporation of the derivative code into the second wireless signal; and
wherein the control unit comprises:
means for transmitting the first and second wireless signals,
means for receiving the first and second responsive signals transmitted from the device,
means for processing the first responsive signals and for generating the second wireless signal incorporating the derivative code, and
means for controlling operation of an access device upon the receipt of the second responsive signal.

6. The system of claim 5, wherein the access device is a door installed in a building.

7. The system of claim 5, wherein the access device is a vehicle.

8. A wireless security access system, comprising:
a control unit configured to transmit an initiating wireless signal;
a portable unit configured to recognize the initiating wireless signal and programmed to initiate two-way wireless communications with the control unit upon the recognition of the initiating wireless signal, wherein the two-way wireless communication between the control and portable units are designed to identify each other, and wherein the control unit is programmed to issue a command upon the mutual identification by the control and portable units; and
a locking device is configured to operate in accordance with the command from the control unit.

9. The system of claim 8, wherein the two-way wireless communications comprises:
a random code signal from the portable unit to the control unit, the random code signal representing a random code; and
a derivative signal from the control unit to the portable unit, the derivative signal representing a derivative of the random code.

10. The system of claim 9, wherein the two-way wireless communications further comprise an identification signal from the portable unit to the control unit, and wherein the identification signal represents an identification code of the portable unit.

11. The system of claim 10, wherein the portable unit is programmed to transmit the identification signal along with the random code signal.

12. The system of claim 8, wherein the two-way wireless communications further comprise a confirmation signal being communicated from the portable unit to the control unit, confirming completion of the mutual identification.

13. The system of claim 9, wherein the random code comprises a random period code.

14. The system of claim 8, wherein the locking device is configured to lock a door of a building or a vehicle.

15. The system of claim 14, wherein the locking device is for a vehicle door, and wherein the control unit is configured to further issue a signal for ignition of an engine of the vehicle.

16. The system of claim 8, wherein the locking device comprises a locking member for locking the door, a solenoid configured to rotate the locking member and an engagement member configured to prevent the locking member from rotating.

17. The system of claim 8, wherein the control unit is further configured to issue another command for an electrical device.

18. The system of claim 17, wherein the control unit is further configured to communicate through a telephone line, and wherein the command for the electrical device is based on communication through the telephone line.

19. A method of identifying a counterpart of wireless communication, the method comprising:
detecting by a portable unit a first wireless signal with an intensity level equal to or higher than a predetermined level;
upon the detection of the first wireless signal with the intensity level, wirelessly transmitting from the portable unit a signal representing an identification code of the portable unit and a random security code;
receiving by the portable unit a second wireless signal incorporating a derivative code of the security code; and
wirelessly transmitting from the portable unit a confirmation signal confirming the incorporation of the derivative code into the second wireless signal

20. The method of claim 19, wherein the portable unit is in a low power consumption mode before detecting the first wireless signal with an intensity equal to or higher than the predetermined level.

21. The method of claim 20, further comprising the portable unit's changing the power consumption to a mode of increased power consumption upon the detection of the first wireless signal with an intensity equal to or higher than the predetermined level.

22. The method of claim 21, further comprising the portable unit's changing the power consumption to the increased power consumption mode only while the portable unit is in motion.

23. A process of operating a security access system, comprising:
transmitting a first wireless signal from a control unit;
receiving the first wireless signal by a portable unit;
generating and transmitting by the portable unit a second wireless signal in response to the first wireless signal, the second wireless signal comprising a signal identifying the portable unit;
receiving the second wireless signal and identifying the portable unit based on the identifying signal by the control unit; and
transmitting from the control unit a command signal for an operation of a locking device.

24. The process of claim 23, wherein the second wireless signal further comprises a signal indicative of a random security code.

25. The process of claim 23, further comprising the control unit's generating and transmitting a third wireless signal comprising a security signal.

26. The process of claim 25, wherein the second wireless signal further comprises a random security code, and wherein the security signal of the third wireless signal is derivative of the random security code.

27. The process of claim 25, wherein the second wireless signal further comprises a signal indicative of a random security code, and wherein generating the security signal of the third wireless signal comprises frequency-converting the signal indicative of the random security code.

28. The process of claim 25, further comprising the portable unit's receiving the third wireless signal and identifying the security signal from the control unit.

29. The process of claim 28, wherein the second wireless signal further comprises a random security code, and wherein the identification of the security signal comprises confirming that the security signal represents a derivative code of the random security code.

30. The process of claim 28, further comprising the portable unit's generating and transmitting a fourth wireless signal in response to the identification of the security signal.

31. The process of claim 30, further comprising the control unit's receiving the fourth wireless signal, and wherein the control unit transmits the command upon the receipt of the fourth wireless signal.

32. The process of claim 23, further comprising changing or maintaining power consumption in the portable unit to a mode of minimum power consumption when the intensity of the received first wireless signal is lower than a predetermined level.

33. The process of claim 32, further comprising changing the power consumption in the portable unit to a mode of increased power consumption when the intensity of the received first wireless signal is equal to or higher than the predetermined level.

34. The process of claim 23, wherein the portable unit is activated upon the receipt of a predetermined intensity of the first wireless signal.

35. The process of claim 23, wherein the transmission of the command signal for the locking device is either wireless-transmission or wire-transmission.

36. The process of claim 23, wherein the locking device is configured to lock or unlock a door.

37. The process of claim 36, wherein the door comprises a door of a vehicle or a building.

38. The process of claim 37, wherein the control unit is installed in the vehicle or the building.

39. An apparatus for identifying a counterpart of wireless communication, the apparatus comprising:
a receiver for receiving incoming signals;
a processor for processing the received signals;
a transmitter for transmitting signals; and
wherein the processor is programmed to isolate an encrypted code from the incoming signals and to generate a derivative code of the encrypted code, and wherein the transmitter is configured to transmit a reply signal incorporating the derivative code.

40. The apparatus of claim 39, wherein the encrypted code is a random period code.
